(19) United States
(12) Patent Application Publication
(10) Pub. No.: US 2022/0239831 A1
(43) Pub. Date: Jul. 28, 2022

(54) TRANSMISSION DEVICE, TRANSMISSION METHOD, RECEPTION DEVICE, RECEPTION METHOD, AND TRANSMISSION-RECEPTION DEVICE

(71) Applicant: SONY SEMICONDUCTOR SOLUTIONS CORPORATION, KANAGAWA (JP)

(72) Inventor: TAKASHI HOSOE, KANAGAWA (JP)

(21) Appl. No.: 17/595,999

(22) PCT Filed: Jun. 1, 2020
(86) PCT No.: PCT/JP2020/021544

§ 371 Date: Dec. 1, 2021

(30) Foreign Application Priority Data
Jun. 14, 2019 (JP) 2019-110793

(51) Int. Cl. H04N 5/232; H04N 5/38

(52) U.S. Cl. CPC H04N 5/23227; G06V 10/25; H04N 5/38; H04N 5/23229

(57) ABSTRACT

The present technology relates to a transmission device, a transmission method, a reception device, a reception method, and a transmission-reception device capable of storing a plurality of pieces of data having different bit widths in a payload of one packet and transmitting the data.

A transmission device according to one aspect of the present technology generates a packet used for transmission of data of each line constituting a frame in which data to be transmitted is arranged in a predetermined format by adding, to a payload storing a plurality of types of unit data having different bit widths for each data unit, a header including separation information including an identifier representing that the plurality of types of the unit data is stored in the payload, and transmits the packet. The present technology can be applied to devices that perform SLVS-EC standard communication.

### TECHNICAL FIELD

The present technology relates to a transmission device, a transmission method, a reception device, a reception method, and a transmission-reception device, and more particularly to a transmission device, a transmission method, a reception device, a reception method, and a transmission-reception device capable of storing a plurality of pieces of data having different bit widths in a payload of one packet and transmitting the plurality of pieces of data.

### BACKGROUND ART

As a standard of an interface for data transmission between chips such as between an image sensor and a DSP, there are a Mobile Industry Processor Interface (MIPI) standard and a Scalable Low Voltage Signaling-Embedded Clock (SLVS-EC) standard.

In the MIPI standard and the SLVS-EC standard, data of respective pixels constituting an image of one frame to be transmitted is stored in a payload of one packet in units of one line and transmitted. In the payload of one packet, data of pixels of one type of gradation with the same bit width constituting one line is stored.

### CITATION LIST

### Patent Document

Patent Document 1: Japanese Patent Application Laid-Open No. 2012-120159

### SUMMARY OF THE INVENTION

### Problems to be Solved by the Invention

In the conventional MIPI standard or the like, data of pixels of a plurality of types of gradations having different bit widths cannot be stored in a payload of one packet and transmitted.

The present technology has been made in view of such a situation, and enables a plurality of pieces of data having different bit widths to be stored in a payload of one packet and transmitted.

### Solutions to Problems

A transmission device according to a first aspect of the present technology includes a packet generation unit that generates a packet used for transmission of data of each line constituting a frame in which data to be transmitted is arranged in a predetermined format by adding, to a payload storing a plurality of types of unit data having different bit widths for each data unit, a header including separation information including an identifier representing that the plurality of types of the unit data is stored in the payload, and a transmission unit that transmits the packet.

A reception device according to a second aspect of the present technology includes a reception unit that receives a packet that is used for transmission of data of each line constituting a frame in which data to be transmitted is arranged in a predetermined format and is generated by adding, to a payload storing a plurality of types of unit data having different bit widths for each data unit, a header including separation information including an identifier representing that the plurality of types of the unit data is stored in the payload, and a separation unit that separates respective pieces of the unit data having different bit widths on the basis of the separation information and outputs the unit data.

In the first aspect of the present technology, a packet used for transmission of data of each line constituting a frame in which data to be transmitted is arranged in a predetermined format is generated by adding, to a payload storing a plurality of types of unit data having different bit widths for each data unit, a header including separation information including an identifier representing that the plurality of types of the unit data is stored in the payload, and the packet is transmitted.

In the second aspect of the present technology, a packet is received that is used for transmission of data of each line constituting a frame in which data to be transmitted is arranged in a predetermined format and is generated by adding, to a payload storing a plurality of types of unit data having different bit widths for each data unit, a header including separation information including an identifier representing that the plurality of types of the unit data is stored in the payload, and respective pieces of the unit data having different bit widths are separated on the basis of the separation information and the unit data is output.

### BRIEF DESCRIPTION OF DRAWINGS

FIG. 1 is a diagram illustrating a configuration example of a transmission system according to one embodiment of the present technology.

FIG. 2 is a diagram illustrating an example of a format used for data transmission.

FIG. 3 is an enlarged diagram illustrating information included in a header.

FIG. 4 is a diagram illustrating an example of data stored in a payload.

FIG. 5 is a diagram illustrating an example of data transmission.

FIG. 6 is a diagram illustrating an example of a Multi-camera system.

FIG. 7 is a diagram illustrating an example of an ROI sensor system.

FIG. 8 is a diagram illustrating an example of an output of an ROI sensor.

FIG. 9 is a diagram illustrating an example of a storage pattern.

FIG. 10 is a diagram illustrating another example of the storage pattern.

FIG. 11 is a diagram illustrating still another example of the storage pattern.

FIG. 12 is a diagram illustrating an example of the storage pattern.

FIG. 13 is a diagram illustrating an example of separation information.

FIG. 14 is a diagram illustrating an example of a meaning of a value of Data ID.

FIG. 15 is a diagram illustrating a setting example of the Data ID.

FIG. 16 is a diagram illustrating another setting example of the Data ID.

FIG. 17 is a diagram illustrating a usage example of separation information.

FIG. 18 is a diagram illustrating another usage example of the separation information.

FIG. 19 is a diagram illustrating an example of an ROI image.

FIG. 20 is a diagram illustrating an example of storage of the separation information.

FIG. 21 is a block diagram illustrating a configuration example of a transmission unit.

FIG. 22 is a diagram illustrating an example of data transmission.

FIG. 23 is a diagram illustrating an example of a stream.

FIG. 24 is a block diagram illustrating another configuration example of the transmission unit.

FIG. 25 is a diagram illustrating another example of data transmission.

FIG. 26 is a diagram illustrating an example of a stream.

FIG. 27 is a block diagram illustrating a configuration example of a reception unit.

FIG. 28 is a flowchart describing processing of the transmission unit.

FIG. 29 is a flowchart describing processing of the reception unit.

FIG. 30 is a diagram illustrating an example of a TOF sensor system.

FIG. 31 is a diagram illustrating an example of a format of output data of a TOF sensor.

FIG. 32 is a diagram illustrating a configuration example of a packet.

FIG. 33 is a diagram illustrating a configuration example of the transmission unit and the reception unit.

FIG. 34 is a diagram illustrating an example of header information.

FIG. 35 is a diagram illustrating an example of Pixel to Byte conversion in a case where a pixel value of each pixel is represented by eight bits.

FIG. 36 is a diagram illustrating an example of the Pixel to Byte conversion in a case where the pixel value of each pixel is represented by 10 bits.

FIG. 37 is a diagram illustrating an example of the Pixel to Byte conversion in a case where the pixel value of each pixel is represented by 12 bits.

FIG. 38 is a diagram illustrating an example of the Pixel to Byte conversion in a case where the pixel value of each pixel is represented by 14 bits.

FIG. 39 is a diagram illustrating an example of the Pixel to Byte conversion in a case where the pixel value of each pixel is represented by 16 bits.

FIG. 40 is a diagram illustrating an example of payload data.

FIG. 41 is a diagram illustrating another example of the payload data.

FIG. 42 is a diagram illustrating an example of payload data in which a parity is inserted.

FIG. 43 is a diagram illustrating a state where a header is added to the payload data.

FIG. 44 is a diagram illustrating a state where the header and a footer are added to the payload data.

FIG. 45 is a diagram illustrating a state where the header is added to the payload data in which the parity is inserted.

FIG. 46 is a diagram illustrating an example of assignment of packet data.

FIG. 47 is a diagram illustrating an example of control codes.

FIG. 48 is a diagram illustrating values of K Character.

FIG. 49 is a diagram illustrating an example of insertion of a Pad Code.

FIG. 50 is a diagram illustrating an example of packet data after insertion of control code.

FIG. 51 is a diagram illustrating an example of correcting Data Skew.

FIG. 52 is a block diagram illustrating a configuration example of a computer.

### MODE FOR CARRYING OUT THE INVENTION

Hereinafter, a mode for carrying out the present technology will be described. The description will be made in the following order.

1. Configuration example of transmission system

2. Frame format

3. Example of payload storing data of plurality of pixels having different gradations

4. Application Examples

5. Example of storage pattern

6. Example of separation information

7. Configurations of transmission unit and reception unit

8. Operations of transmission unit and reception unit

9. Examples of other applications

10. SLVS-EC standard

11. Modification Example

### Configuration Example of Transmission System

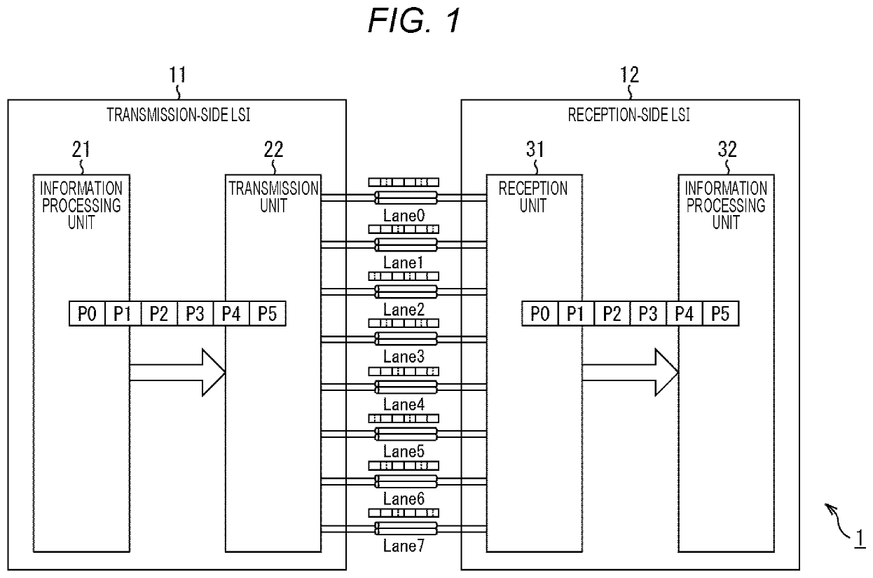

FIG. 1 is a diagram illustrating a configuration example of a transmission system according to one embodiment of the present technology.

The transmission system 1 in FIG. 1 includes a transmission-side LSI 11 and a reception-side LSI 12. The transmission-side LSI 11 and the reception-side LSI 12 are provided in the same device having an imaging function, such as a digital camera or a mobile phone, for example. The transmission-side LSI 11 is provided with an information processing unit 21 and a transmission unit 22, and the reception-side LSI 12 is provided with a reception unit 31 and an information processing unit 32.

The information processing unit 21 of the transmission-side LSI 11 includes an imaging element such as a complementary metal oxide semiconductor (CMOS) image sensor. The information processing unit 21 performs A/D conversion and the like of a signal obtained by photoelectric conversion of light received by the imaging element, and sequentially outputs pixel data constituting an image of one frame to the transmission unit 22 by data of one pixel.

The transmission unit 22 assigns data of each pixel supplied from the information processing unit 21 to a plurality of transmission lines in the order of supply from the information processing unit 21, for example, and transmits the data to the reception-side LSI 12 in parallel via the plurality of transmission lines. In the example of FIG. 1, pixel data is transmitted using eight transmission lines. The transmission line between the transmission-side LSI 11 and the reception-side LSI 12 may be a wired transmission line or a wireless transmission line. Hereinafter, a transmission line between the transmission-side LSI 11 and the reception-side LSI 12 is appropriately referred to as a lane.

The reception unit 31 of the reception-side LSI 12 receives the pixel data transmitted from the transmission unit 22 via the eight lanes, and sequentially outputs data of each pixel to the information processing unit 32.

The information processing unit 32 generates an image of one frame on the basis of the pixel data supplied from the reception unit 31, and performs various types of image processing using the generated image. Image data transmitted from the transmission-side LSI 11 to the reception-side LSI 12 is, for example, RAW data, and the information processing unit 32 performs various processes such as compression of image data, display of an image, and recording of image data on a recording medium. In addition to the RAW data, JPEG data and additional data other than the pixel data may be transmitted from the transmission-side LSI 11 to the reception-side LSI 12.

As described above, data is transmitted and received using a plurality of lanes between the transmission unit 22 provided in the transmission-side LSI 11 of the transmission system 1 and the reception unit 31 provided in the reception-side LSI 12.

It is also possible to provide the same numbers of transmission units 22 and reception units 31. In this case, data transmission and reception using the plurality of lanes is performed between each set of the transmission unit 22 and the reception unit 31.

Transmission and reception of data between the transmission unit 22 and the reception unit 31 is performed according to, for example, the SLVS-EC standard.

In the SLVS-EC standard, an application layer (Application Layer), a link layer (LINK Layer), and a physical layer (PHY Layer) are defined according to the content of signal processing. The signal processing of each layer is performed by the transmission unit 22 that is a transmitting side (Tx) and the reception unit 31 that is a receiving side (Rx).

Although details will be described later, in the link layer, signal processing for achieving the following functions is basically performed.

1. Pixel data-byte data conversion

2. Error correction of payload data

3. Transmission of packet data and auxiliary data

4. Error correction of payload data using packet footer

5. Lane management

6. Protocol management for packet generation

On the other hand, in the physical layer, signal processing for achieving the following functions is basically performed.

1. Generation and extraction of control code

2. Bandwidth control

3. Control of skew between lanes

4. Arrangement of symbols

5. Symbol coding for bit synchronization

6. SERDES (SERializer/DESerializer)

7. Generation and reproduction of clock

8. Transmission of Scalable Low Voltage Signaling (SLVS) signal

### Frame Format

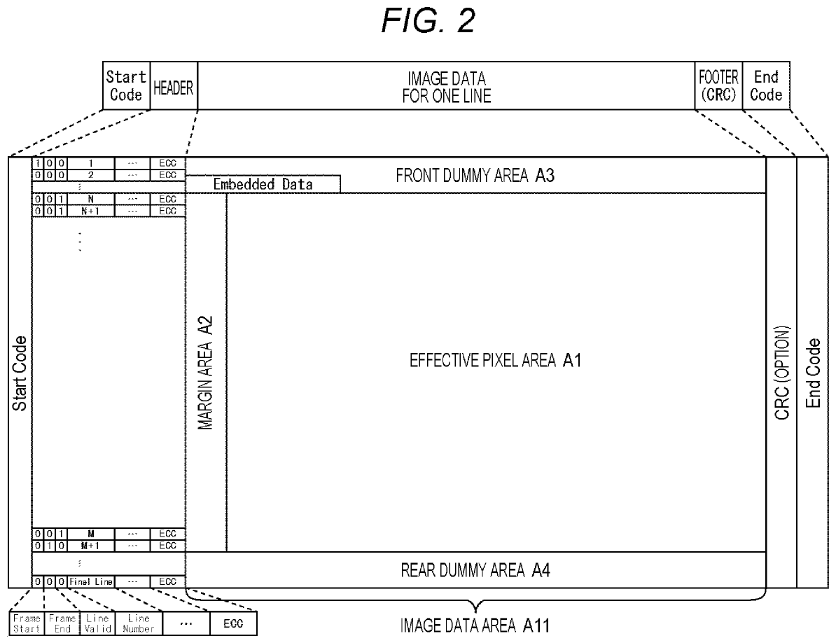

FIG. 2 is a diagram illustrating an example of a format used for data transmission between the transmission-side LSI 11 and the reception-side LSI 12.

Between the transmission-side LSI 11 and the reception-side LSI 12, for example, data is transmitted for each image of one frame using a frame format as illustrated in FIG. 2. Transmission of images of a plurality of frames may be performed using a frame format as illustrated in FIG. 2.

The effective pixel area A1 is an area of effective pixels of the captured image. An image to be transmitted is arranged in the effective pixel area A1. On the left side of the effective pixel area A1, a margin area A2 is set in which the number of pixels in a vertical direction is the same as the number of pixels in the vertical direction of the effective pixel area A1.

On an upper side of the effective pixel area A1, a front dummy area A3 is set in which the number of pixels in a horizontal direction is the same as the number of pixels in the horizontal direction of the entire effective pixel area A1 and margin area A2. In the example of FIG. 2, Embedded Data is inserted in the front dummy area A3. The Embedded Data includes information of set values related to imaging by the information processing unit 21, such as shutter speed, aperture value, and gain. The Embedded Data may be inserted in a rear dummy area A4.

The rear dummy area A4 is set below the effective pixel area A1 in which the number of pixels in the horizontal direction is the same as the number of pixels in the horizontal direction of the entire effective pixel area A1 and margin area A2.

An image data area A11 includes the effective pixel area A1, the margin area A2, the front dummy area A3, and the rear dummy area A4.

A header is added before each line constituting the image data area A11, and a Start Code is added before the header. Furthermore, a footer is optionally added after each line constituting the image data area A11, and a control code as described later such as End Code is added after the footer. In a case where the footer is not added, a control code such as End Code is added after each line constituting the image data area A11.

For example, every time an image of one frame is transmitted from the transmission-side LSI 11 to the reception-side LSI 12, the entire data in the format illustrated in FIG. 2 is transmitted as transmission data.

A band illustrated in an upper part of FIG. 2 illustrates a structure of a packet used for transmitting transmission data illustrated in a lower part. Assuming that an arrangement of pixels in the horizontal direction is a line, data of pixels constituting one line of the image data area A11 is stored in the payload of one packet. Transmission of the entire image data of one frame is performed using the number of packets equal to or larger than the number of pixels in the vertical direction of the image data area A11.

One packet is formed by adding the header and the footer to the payload in which pixel data for one line is stored. The header includes additional information of the pixel data stored in the payload, such as Frame Start, Frame End, Line Valid, and Line Number. At least a Start Code and an End Code that are control codes are added to each packet.

Thus, by employing the format in which the pixel data constituting an image of one frame is transmitted for every line, additional information such as the header and control codes such as the Start Code and the End Code can be transmitted during a blanking period of every line.

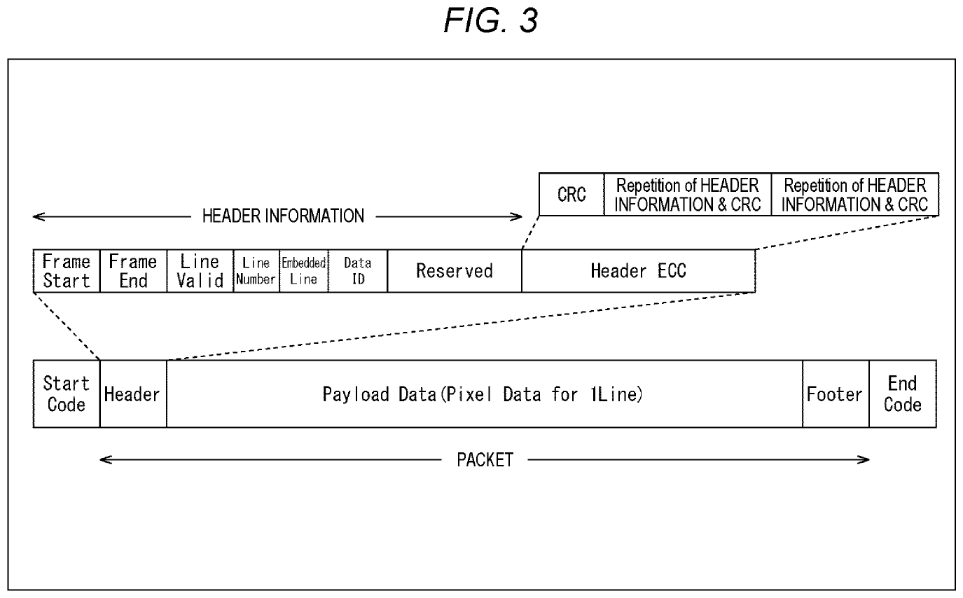

FIG. 3 is an enlarged diagram illustrating information included in the header.

As illustrated in FIG. 3, the header includes header information and Header ECC.

The header information includes Frame Start, Frame End, Line Valid, Line Number, Embedded Line, Data ID, and Reserved.

The Frame Start is one-bit information indicating the beginning of a frame. A value of 1 is set to the Frame Start of the header of a packet used for transmission of pixel data of the first line in the image data area A11 of FIG. 2, and a value of 0 is set to the Frame Start of the header of a packet used for transmission of pixel data of another line.

The Frame End is one-bit information indicating the end of the frame. A value of 1 is set to Frame End of the header of a packet including pixel data of an end line of the effective pixel area A1 in the payload, and a value of 0 is set to Frame End of the header of the packet used for transmission of pixel data of another line.

The Frame Start and Frame End are frame information which is information regarding the frame.

The Line Valid is 1-bit information representing whether or not a line of pixel data stored in the payload is a line of effective pixels. A value of 1 is set to the Line Valid of the header of a packet used for transmission of pixel data of a line in the effective pixel area A1, and a value of 0 is set to the Line Valid of the header of a packet used for transmission of pixel data of another line.

The Line Number is 13-bit information representing the line number of a line formed by pixel data stored in the payload.

The Line Valid and Line Number are line information that is information regarding the line.

Embedded Line is one-bit information representing whether or not a packet is used for transmission of a line in which Embedded Data is inserted. For example, a value of 1 is set to Embedded Line of the header of the packet used for transmission of the line including Embedded Data, and a value of 0 is set to Embedded Line of the header of a packet used for transmission of another line.

The Data ID is an identifier of data to be transmitted. For example, four bits are assigned to the Data ID. As described later, the Data ID represents that data of a plurality of pixels having different gradations is stored in the payload.

An area behind the Data ID is a Reserved area.

As illustrated in FIG. 3, the Header ECC arranged following the header information includes a Cyclic Redundancy Check (CRC) code which is an error detection code calculated on the basis of the header information. Furthermore, the Header ECC includes two pieces of the same information as the eight-byte information which is a set of the header information and the CRC code following the CRC code.

That is, the header of one packet includes three sets of the same header information and CRC code. The total amount of data in the entire header is, for example, 24 bytes in total combining eight bytes for a first set of header information and CRC code, eight bytes for a second set of header information and CRC code, and eight bytes for a third set of header information and CRC code.

### Example of Payload Storing Data of Plurality of Pixels Having Different Gradations

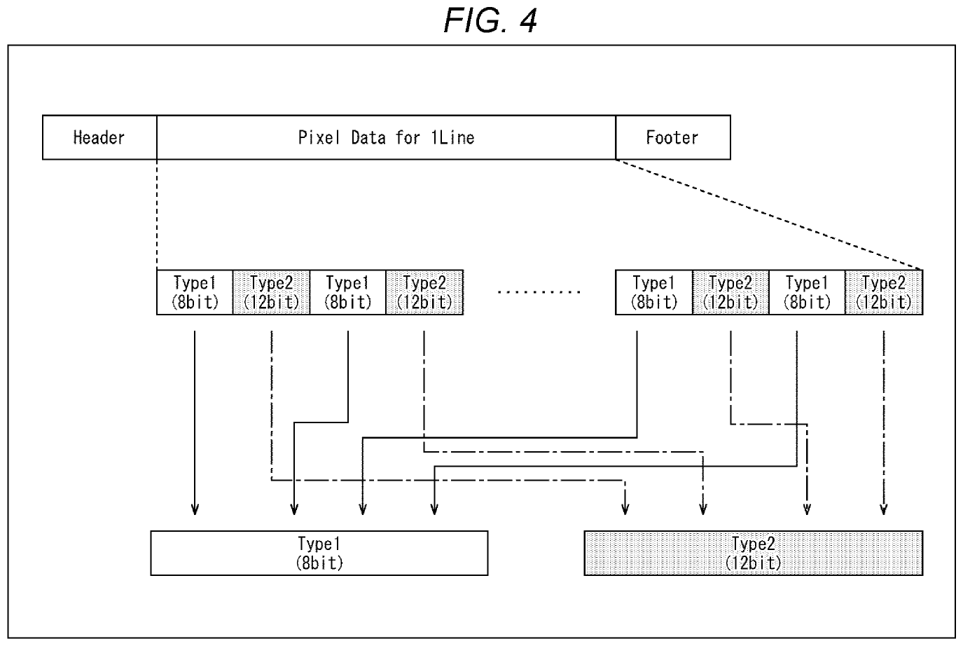

FIG. 4 is a diagram illustrating an example of data stored in the payload.

As illustrated in FIG. 4, the payload of a packet transmitted between the transmission-side LSI 11 and the reception-side LSI 12 stores data of pixels of a plurality of gradations of Type 1 data and Type 2 data.

The Type 1 data is data of pixels of eight-bit gradations (pixels whose gradations are represented by eight bits). The Type 2 data is data of pixels of 12-bit gradations (pixels whose gradations are represented by 12 bits).

That is, in the payload of one packet illustrated in FIG. 4, a plurality of types of unit data having different bit widths per data unit is stored with data of one pixel being unit data.

In the example of FIG. 4, Type 1 data and Type 2 data are alternately arranged. One blocks to which characters of the Type 1 data and the Type 2 data are attached represent data of one pixel of eight bits and data of one pixel of 12 bits, respectively. The storage pattern illustrated in FIG. 4 is a pattern in a case where data of pixels of a plurality of gradations is periodically stored for each data of one pixel.

In the reception unit 31 of the reception-side LSI 12 that has received the packet in which the data as illustrated in FIG. 4 is stored in the payload, one line including eight-bit pixels is acquired by separating the Type 1 data as indicated ahead of solid arrows. Furthermore, one line including 12-bit pixels is acquired by separating the Type 2 data as indicated ahead of arrows of one-dot chain lines.

In addition to the information described with reference to FIG. 3, the header includes information representing that data of pixels of a plurality of gradations is stored in the payload, and information representing periods and ranges of the Type 1 data and the Type 2 data. In the reception-side LSI 12, the Type 1 data and the Type 2 data are separated on the basis of the separation information including these pieces of information.

By sequentially separating the Type 1 data and the Type 2 data for the packet transmitting each line constituting one frame, in the reception-side LSI 12, the entire image of one frame including eight-bit pixels and the entire image of one frame including 12-bit pixels are acquired.

Thus, in a case where the entire data of the pixels of one line is transmitted using one packet, the data of pixels of a plurality of gradations is allowed to be mixed in one payload, and thereby the efficiency of data transmission can be improved.

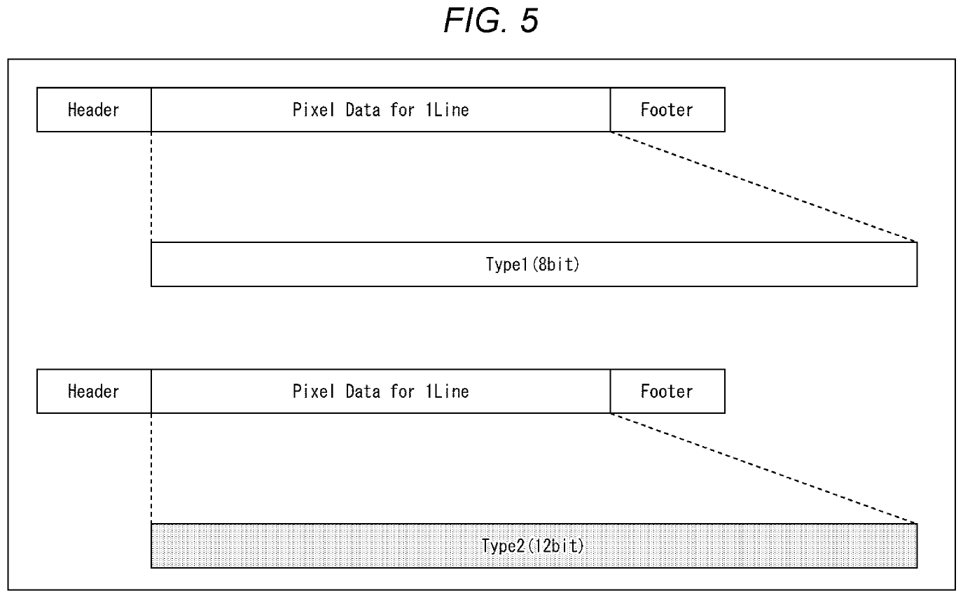

A case where data of pixels of a plurality of gradations cannot be mixed in one payload, that is, a case where only data of pixels of one type of gradation can be stored in the payload of one packet will be considered. In this case, when it is assumed that an eight-bit image (an image including eight-bit pixels) and a 12-bit image (an image including 12-bit pixels) are transmitted, it is necessary to use two packets for each line as illustrated in FIG. 5.

As described with reference to FIG. 3, in the SLVS-EC standard, a control code is set every time data of one line is transmitted. In a case where two packets are transmitted, the efficiency of data transmission decreases as the number of control codes and the like increases as compared with a case where one packet is transmitted. By allowing data of pixels of a plurality of gradations to be mixed in one payload, it is possible to prevent such a decrease in data transmission efficiency.

<Example of Application>

A transmission method in which data of pixels of a plurality of gradations is mixed in one payload can be applied to various applications. Hereinafter, a transmission method in which data of pixels of a plurality of gradations is mixed in one payload is appropriately referred to as a multi-gradation transmission method.

Multi-Camera (Multi-Eye) System

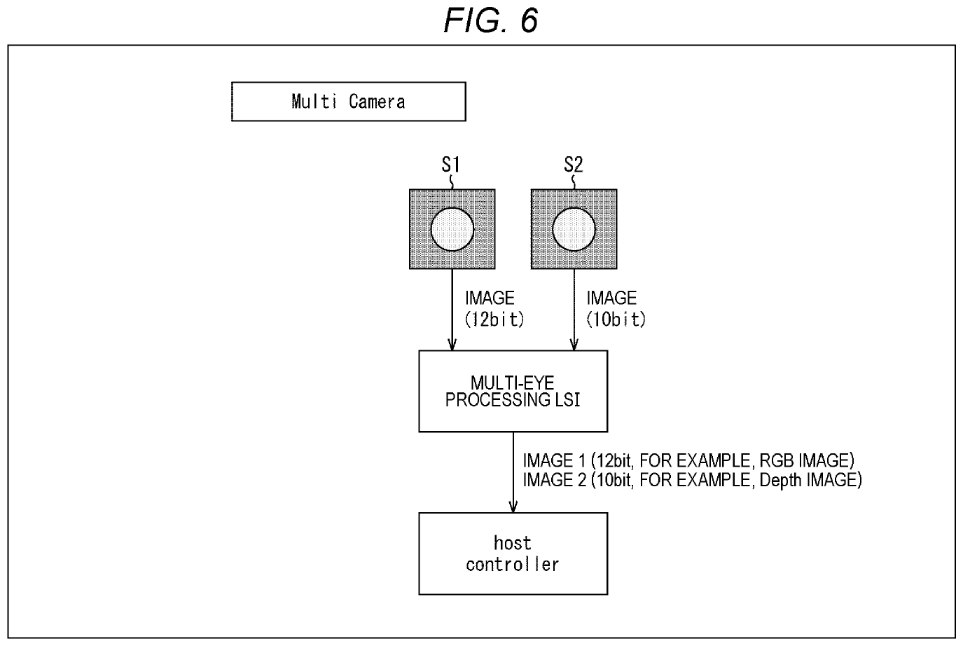

FIG. 6 is a diagram illustrating an example of a Multi-camera system.

The Multi-camera system is a system that transmits a plurality of images obtained by, for example, simultaneously capturing images by a plurality of image sensors.

In the example of FIG. 6, a 12-bit image captured by the image sensor S1 and a 10-bit image captured by the image sensor S2 are output from the respective image sensors and input to a multi-eye processing LSI.

In the multi-eye processing LSI, a packet in which the entire pixels of a predetermined line constituting a 12-bit image and the entire pixels of a predetermined line constituting a 10-bit image are stored in one payload is generated and transmitted to the host controller. In the example of FIG. 6, the 12-bit image captured by the image sensor S1 is an RGB image, and the 10-bit image captured by the image sensor S2 is a Depth image.

Thus, in the Multi-camera system, the multi-gradation transmission method is used for data transmission from the multi-eye processing LSI to the host controller.

In a case where the Multi-camera system is implemented in the configuration of the transmission system 1 in FIG. 1, for example, the functions of the image sensors S1 and S2 are implemented by the information processing unit 21 (a plurality of image sensors is provided in the information processing unit 21). Furthermore, the function of the multi-eye processing LSI is implemented by the transmission unit 22. The function of the host controller is implemented by the reception unit 31 and the information processing unit 32.

By applying the multi-gradation transmission method to the Multi-camera system, a 12-bit RGB image and a 10-bit Depth image can be efficiently transmitted, and low-latency data transmission can be achieved.

Region of Interest (ROI) Sensor System

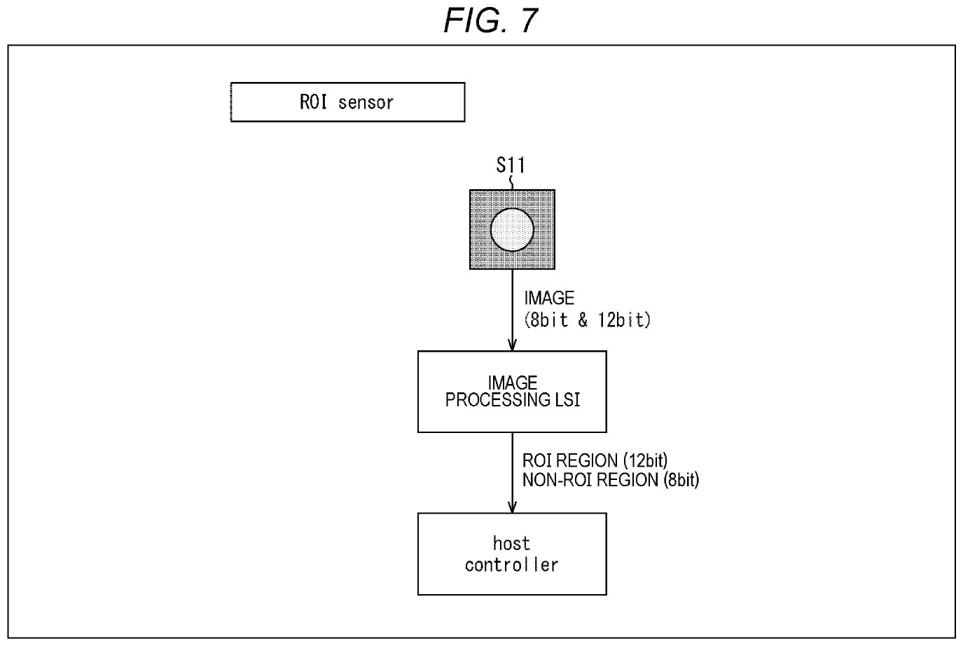

FIG. 7 is a diagram illustrating an example of an ROI sensor system.

The ROI sensor system is a system that sets an ROI region (region of interest) and a non-ROI region by analyzing an image, and transmits data of pixels in each region as data of different gradations.

In the example of FIG. 7, for example, pixels of a 12-bit ROI region and pixels of an eight-bit non-ROI region obtained by analyzing a captured image in the ROI sensor S11 are output from the ROI sensor S11 and input to the image processing LSI.

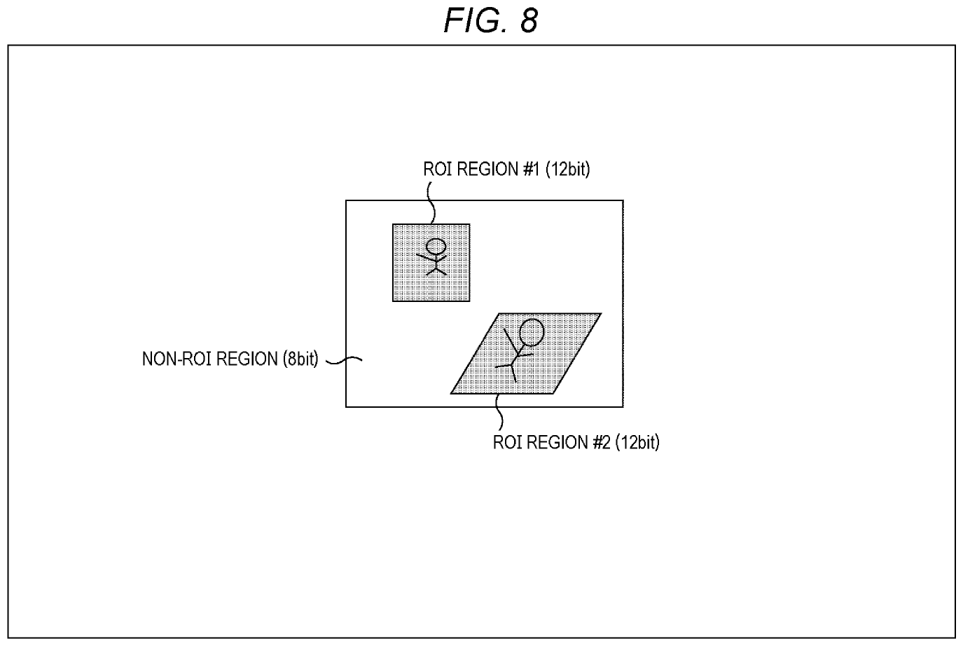

FIG. 8 is a diagram illustrating an example of an output of the ROI sensor S11.

In the ROI sensor S11, the ROI region and the non-ROI region are set as illustrated in FIG. 8 on the basis of an analysis result of the image. In the example of FIG. 8, in the entire image, a substantially square region on an upper left and a parallelogram region on a lower right are set as ROI regions #1 and #2, respectively, and other regions are set as non-ROI regions.

In the image processing LSI of FIG. 7, at the time of transmission of a predetermined line constituting an image, when pixels of the ROI region and pixels of the non-ROI region are included in the line, a packet in which the pixels of the ROI region and the pixels of the non-ROI region having different gradations are stored in one payload is generated and transmitted to the host controller.

Thus, in the ROI sensor system, the multi-gradation transmission method is used for data transmission from the image processing LSI to the host controller.

In a case where the ROI sensor system is implemented in the configuration of the transmission system 1 of FIG. 1, for example, the function of the ROI sensor S11 is implemented by the information processing unit 21, and the function of the image processing LSI is implemented by the transmission unit 22. The function of the host controller is implemented by the reception unit 31 and the information processing unit 32.

By applying the multi-gradation transmission method to the ROI sensor system, it is possible to efficiently transmit data of the 12-bit ROI region and data of the eight-bit non-ROI region. Furthermore, data of the non-ROI region can be transmitted in a form in which gradation is suppressed.

As described above, the multi-gradation transmission method can be applied to various systems that transmit data of a plurality of pixels having different gradations. A case of being applied to a system that transmits data other than data of one pixel as unit data will be described later.

### Example of Storage Pattern

Example 1 of Storage Pattern

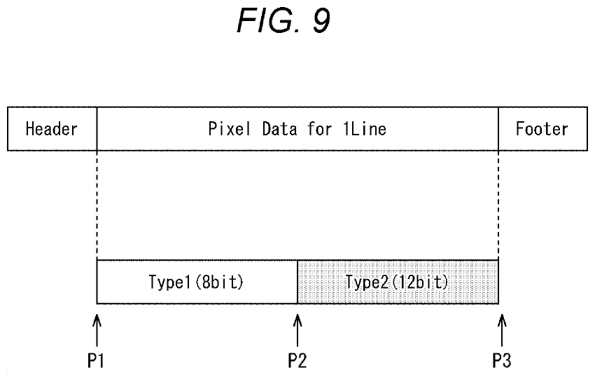

FIG. 9 is a diagram illustrating an example of a storage pattern.

In the example of FIG. 9, in the entire payload, Type 1 data is stored in a section from a position P1 to a position P2, and Type 2 data is stored in a section from the position P2 to a position P3. In the section from the position P1 to the position P2, the Type 1 data is continuously stored by the number of pixels constituting one line. Furthermore, in the section from the position P2 to the position P3, the Type 2 data is continuously stored by the number of pixels constituting one line.

In this case, the separation information stored in the header includes at least information representing the period and range of the Type 1 data and the Type 2 data.

In the reception unit 31, it is specified on the basis of the separation information that the gradation is switched at the position P2, and respective pieces of data of the Type 1 data and the Type 2 data are separated.

Thus, in the multi-gradation transmission method, it is possible to collectively store each of the Type 1 data and the Type 2 data for a plurality of pixels.

Example 2 of Storage Pattern

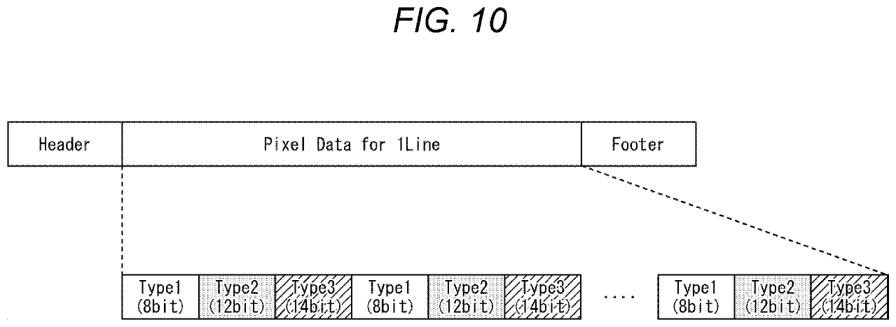

FIG. 10 is a diagram illustrating another example of the storage pattern.

In the example of FIG. 10, data of three types of pixels having different gradations of Type 1 data, Type 2 data, and Type 3 data are alternately arranged. The Type 1 data, the Type 2 data, and the Type 3 data are data of eight-bit, 12-bit, and 14-bit pixels, respectively.

In this case, the separation information stored in the header includes at least information representing the period and range of the Type 1 data, the Type 2 data, and the Type 3 data.

In the reception unit 31, a switching position of gradation is specified on the basis of the separation information, and respective pieces of data of the Type 1 data, the Type 2 data, and the Type 3 data are separated.

Thus, in the multi-gradation transmission method, it is possible to store data of three or more types of pixels having different gradations. There is no limitation on the number of gradations of pixels stored in one payload.

Note that there is no limitation also on the combination of gradations (bit widths) stored in one payload. Not only a combination of eight-bit pixels and 12-bit pixels but also, for example, a combination of 10-bit pixels and 14-bit pixels is possible.

Example 3 of Storage Pattern

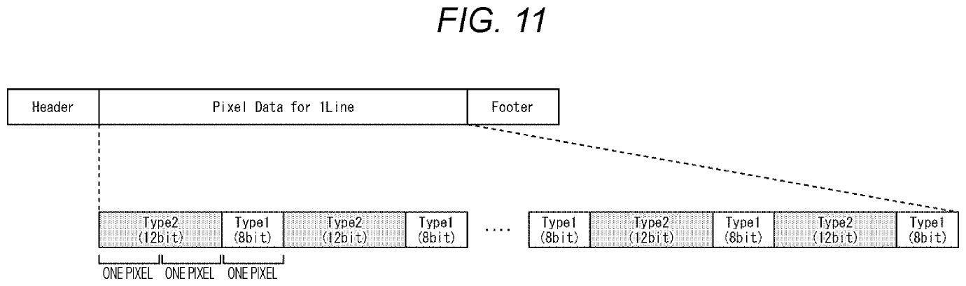

FIG. 11 is a diagram illustrating still another example of the storage pattern.

In the example of FIG. 11, the Type 2 data for two pixels and the Type 1 data for one pixel are alternately stored. In FIG. 11, the width of one block of the Type 2 data that is long represents that Type 2 data for two pixels is continuously stored. The storage pattern illustrated in FIG. 11 is a pattern in a case where data of pixels of a plurality of gradations is stored periodically with the Type 2 data for two pixels being interposed for the Type 1 data, and periodically with the Type 1 data for one pixel being interposed for the Type 2 data.

In this case, the separation information stored in the header includes at least information representing the period and range of the Type 1 data and the Type 2 data.

In the reception unit 31, the switching position of gradation is specified on the basis of the separation information, and the respective pieces of data of the Type 1 data and the Type 2 data are separated.

Thus, in the multi-gradation transmission method, it is possible to store the gradation switching period as different periods between the Type 1 data and the Type 2 data.

Example 4 of Storage Pattern

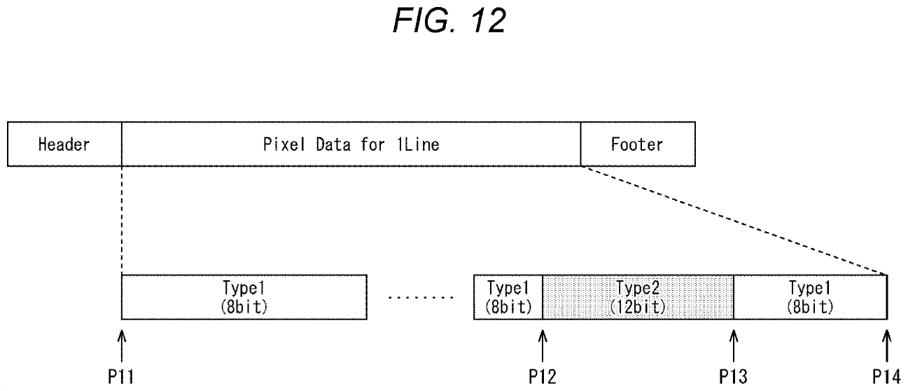

FIG. 12 is a diagram illustrating an example of the storage pattern.

In the example of FIG. 12, in the entire payload, the Type 1 data is stored in a section from a position P11 to a position P12, and the Type 2 data is stored in a section from the position P12 to a position P13. Furthermore, Type 1 data is stored in a section from the position P13 to a position P14.

In each of the section from the position P11 to the position P12 and the section from the position P13 to the position P14, Type 1 data is continuously stored for a plurality of pixels. Furthermore, in the section from the position P12 to the position P13, the Type 2 data is continuously stored for a plurality of pixels.

In this case, the separation information stored in the header includes at least information representing respective ranges of the Type 1 data and the Type 2 data.

In the reception unit 31, it is specified on the basis of the separation information that the gradation is switched at each of the position P12 and the position P13, and the respective pieces of data of the Type 1 data and the Type 2 data are separated.

Thus, in the multi-gradation transmission method, it is possible to partially store the Type 2 data in a predetermined section and store the Type 1 data in another portion.

The storage pattern illustrated in FIG. 12 is used, for example, in a case where pixels in the ROI region and pixels in the non-ROI region are transmitted in the ROI sensor system. As described later, for example, the position P12 corresponds to a start position (a position of a left end pixel) of the ROI region when the beginning (left end) of the line is set as a reference, and the position P13 corresponds to an end position (a position of a right end pixel) of the ROI region.

Note that the storage patterns illustrated in FIGS. 9 to 11 are used in, for example, a Multi-camera system.

Thus, the storage pattern in the multi-gradation transmission method can be arbitrarily selected according to an application or the like.

<Example of Separation Information>

Here, details of the separation information will be described. In the reception unit 31 that has received a packet in which data of pixels of a plurality of gradations is stored in one payload by the multi-gradation transmission method, the data of each pixel is separated on the basis of the separation information included in the header.

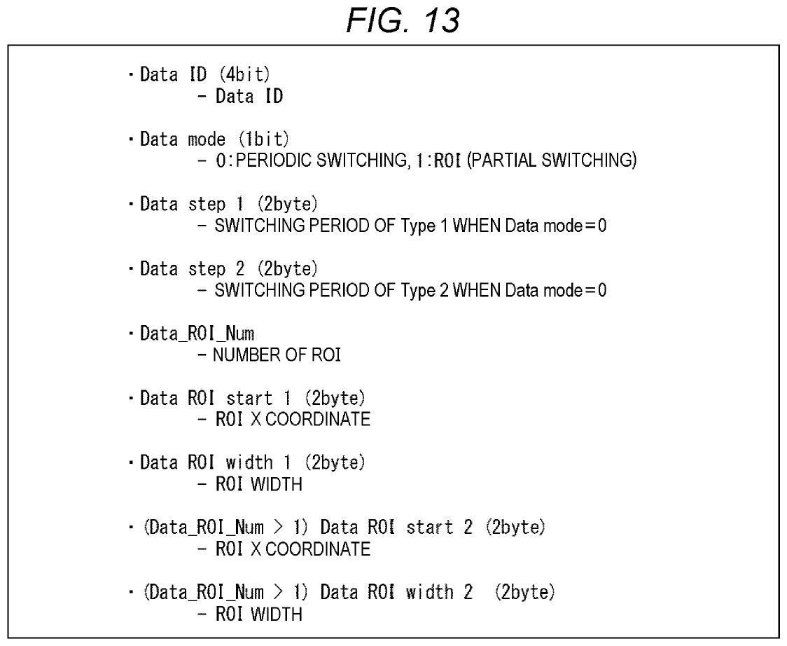

FIG. 13 is a diagram illustrating an example of the separation information.

As illustrated in FIG. 13, in addition to the Data ID (FIG. 3), Data mode, Data step 1, Data step 2, Data_ROI_Num, Data ROI start 1, and Data ROI width 1 are used as the separation information. The Data mode, Data step 1, Data step 2, Data_ROI_Num, Data ROI start 1, and Data ROI width 1 other than the Data ID are described using, for example, a Reserved area (FIG. 3) which is an empty region of the header.

The Data ID is four-bit information. The Data ID represents a data type (Type) of data stored in the payload and is used as an identifier of a Multiple stream.

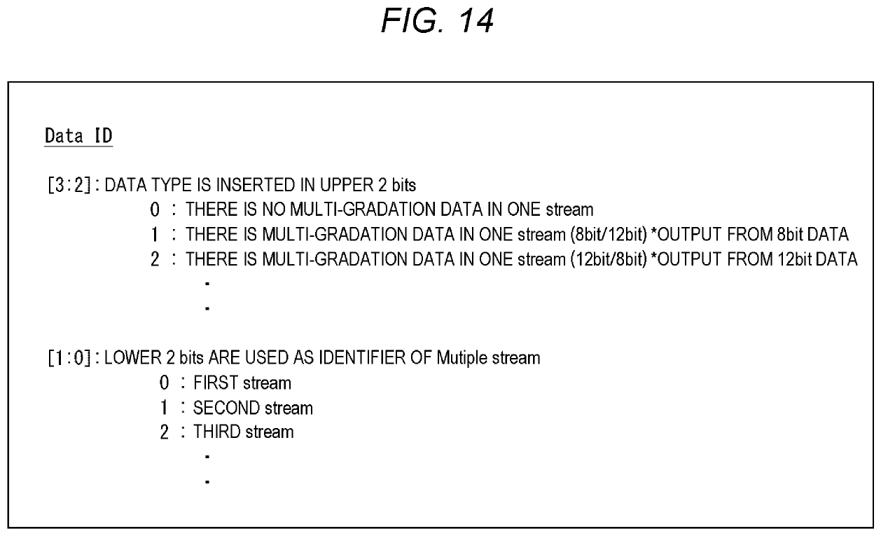

FIG. 14 is a diagram illustrating an example of a meaning of a value of the Data ID.

Upper two bits of [3:2] among the four bits constituting the Data ID represent a data type of data stored in the payload.

For example, a value of the upper two bits of 0 represents that data of a plurality of gradations is not stored in the payload.

A value of the upper two bits of 1 represents that the data of the plurality of gradations is stored in the payload in the order of eight bits and 12 bits.

A value of the upper two bits of 2 represents that the data of the plurality of gradations is stored in the payload in the order of 12 bits and eight bits.

Lower two bits of [1:0] among the four bits constituting the Data ID are used as the identifier of the Multiple stream. Here, the stream corresponds to a data system. The lower two bits of [1:0] are used to identify which system of data the packet is used for transmission.

For example, a value of the lower two bits of 0 represents that the packet is used for transmission of data of a first stream.

A value of the lower two bits of 1 represents that the packet is used for transmission of data of a second stream.

A value of the lower two bits of 2 represents that the packet is used for transmission of data of a third stream.

The bit width assigned to each piece of information can be arbitrarily changed such that upper three bits are used to represent the data type of data stored in the payload, and a lower one bit is used for the identifier of the Multiple stream.

The data type of data stored in the payload may be represented by information of a predetermined number of bits defined separately from the Data ID.

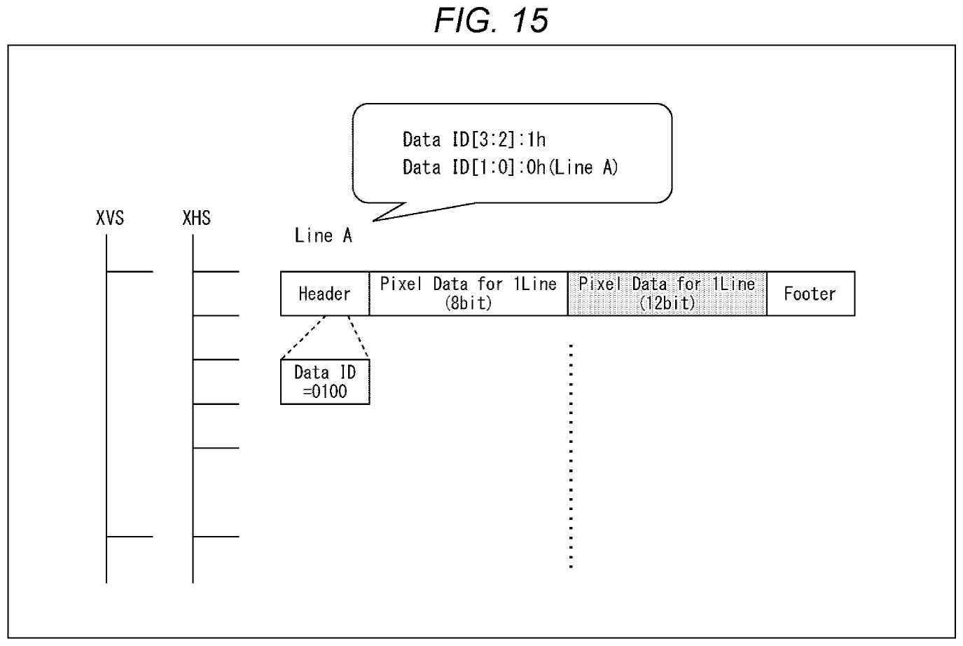

FIG. 15 is a diagram illustrating a setting example of the Data ID.

As illustrated in FIG. 15, in a case where the Type 1 data is stored in a first half of the payload of a packet used for transmission of data of Line A, and the Type 2 data is stored in a second half of the payload, 0100 is set as the value of the Data ID. The data storage pattern illustrated in FIG. 15 is the same as the pattern described with reference to FIG. 9.

The value of upper two bits of the Data ID of 1h(01) represents that data of pixels of a plurality of gradations is stored in the payload in the order of eight bits and 12 bits. Furthermore, the value of the lower two bits of 0h(00) represents that the packet is used for transmission of the data of Line A as the first stream.

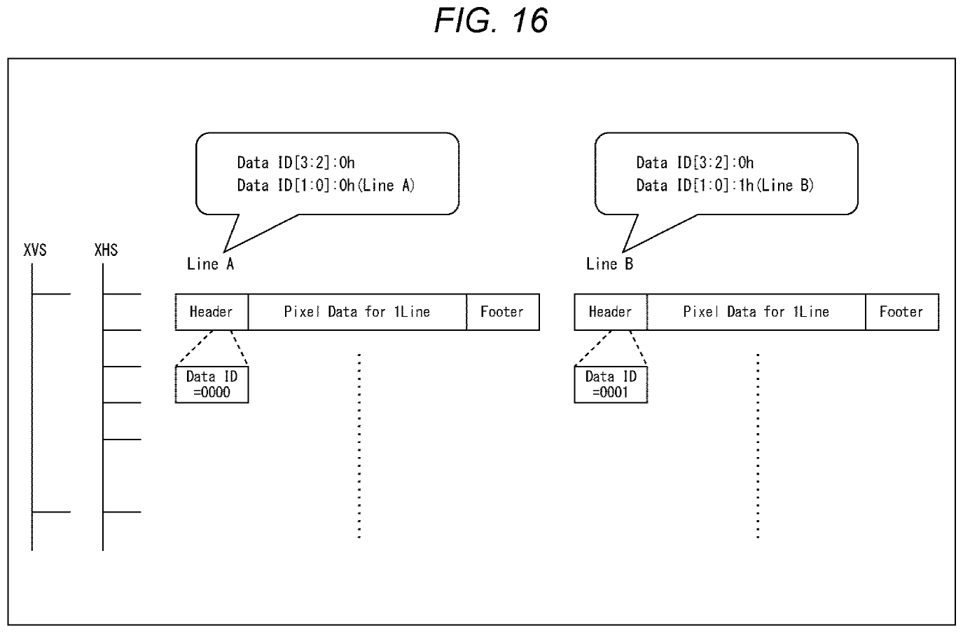

FIG. 16 is a diagram illustrating another setting example of the Data ID.

As illustrated in FIG. 16, a case where the Type 1 data is stored in the entire payload of the packet used for transmission of the data of Line A, and the Type 2 data is stored in the entire payload of a packet used for transmission of data of Line B will be described. In this case, 0000 is set as the value of the Data ID in the packet used for transmission of the data of Line A. Furthermore, 0001 is set as the value of the Data ID in the packet used for transmission of the data of Line B.

The value of the upper two bits of the Data ID of 0h(00) set in the packet used for transmission of the data of Line A represents that the data of pixels of the plurality of gradations is not stored in the payload. Furthermore, the value of the lower two bits of 0h(00) represents that the packet is used for transmission of the data of Line A as the first stream.

On the other hand, the value of the upper two bits of the Data ID of 0h(00) set in the packet used for transmission of the data of Line B represents that the data of pixels of the plurality of gradations is not stored in the payload. Furthermore, the value of the lower two bits of 1h(01) represents that the packet is used to transmit the data of Line B as the second stream.

Thus, the Data ID represents at least whether or not the data of the pixels of the plurality of gradations is stored in the payload, and the arrangement order of data in a case where the data of pixels of the plurality of gradations is stored in the payload.

Returning to the description of FIG. 13, the Data mode is 1-bit information. The Data mode represents whether the gradation of a pixel is periodically switched or partially switched.

For example, a value of the Data mode of 0 represents that the gradation of the pixel is periodically switched.

Furthermore, a value of the Data mode of 1 represents that the gradation of the pixel is partially switched.

The Data step 1 is two-byte information. The Data step 1 represents a switching period of the Type 1 data when the Data mode=0.

The Data step 2 is two-byte information. The Data step 2 represents a switching period of the Type 2 data when the Data mode=0.

The Data_ROI_Num represents the number of ROI regions. In a case where the packet is used for transmission of pixels constituting the ROI region, the number of ROI regions is represented by the Data_ROI_Num. For example, a predetermined bit width corresponding to the maximum number of assumed ROI regions is assigned to the Data_ROI_Num.

The Data ROI start 1 is, for example, two-byte information. The Data ROI start 1 represents the X coordinate (start position) of a first ROI region.

The Data ROI width 1 is, for example, two-byte information. The Data ROI width 1 represents the width of a first ROI region. The coordinate obtained by adding the width designated by the Data ROI width 1 to the X coordinate designated by the Data ROI start 1 is the coordinate of the end position of the first ROI region.

In a case where the value of the Data_ROI_Num is equal to or more than 2, that is, in a case where a packet is used for transmission of pixels constituting two or more ROI regions, the Data ROI start and the Data ROI width are described for each ROI region.

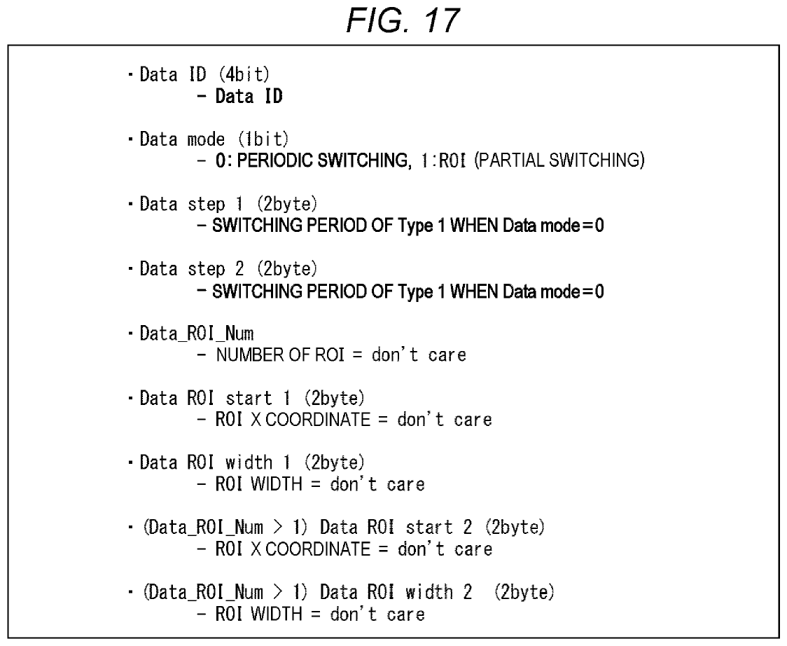

FIG. 17 is a diagram illustrating a usage example of the separation information.

In a case where the multi-gradation transmission method is applied to the Multi-camera system (FIG. 6), the Data ID, the Data mode, the Data step 1, and the Data step 2 among the pieces of information constituting the separation information are used as indicated in bold in FIG. 17.

In a case where the Type 1 data and the Type 2 data are alternately stored in the payload for each piece of data of one pixel (FIG. 4), for example, 0100 is set as the value of the Data ID.

Furthermore, a value of 0 is set as the value of the Data mode, and a value of 1 is set as the values of the Data step 1 and the Data step 2.

The value of the Data mode of 0 represents that the gradation of the pixel is periodically switched. Furthermore, the values of the Data step 1 and the Data step 2 of 1 indicate that each of gradation switching from eight bits to 12 bits and gradation switching from 12 bits to eight bits occurs for each piece of data of one pixel.

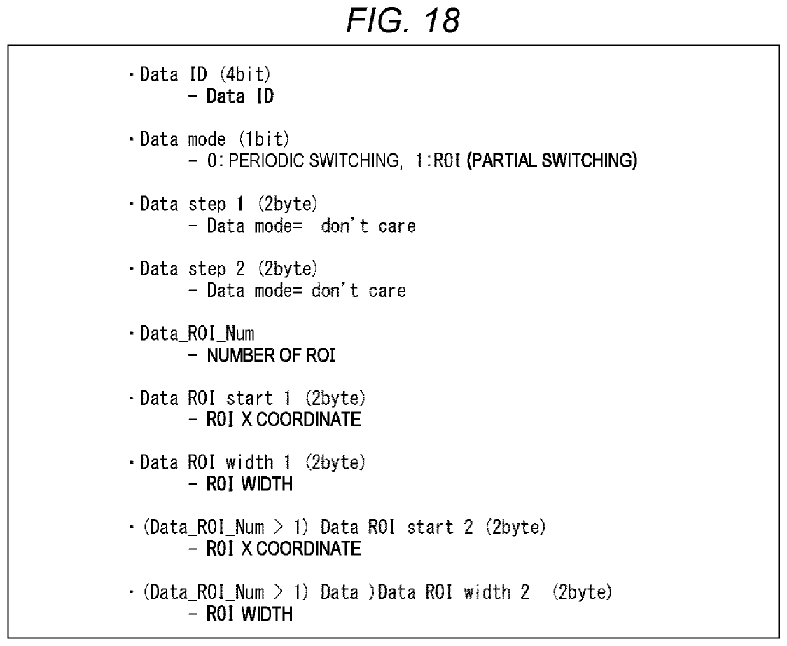

FIG. 18 is a diagram illustrating another usage example of the separation information.

In a case where the multi-gradation transmission method is applied to the ROI sensor system (FIG. 7), the Data ID, the Data mode, the Data_ROI_Num, the Data ROI start 1, and the Data ROI width 1 among the pieces of information constituting the separation information are used as indicated in bold in FIG. 18. The Data ROI start and the Data ROI width are appropriately added and described according to the number of ROI regions.

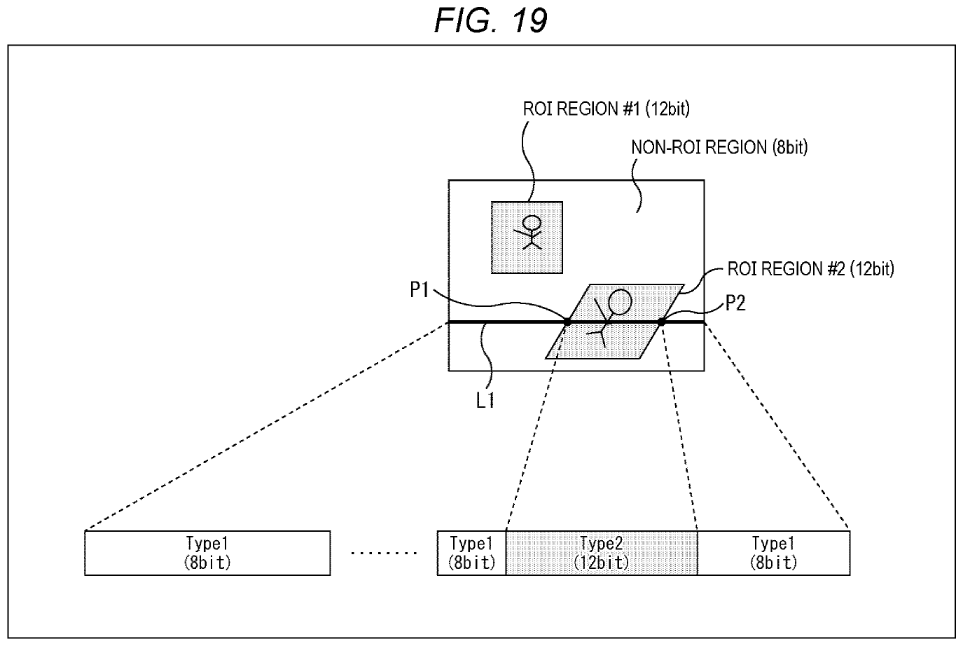

For example, a case where data of pixels of a line L1 indicated by a thick line constituting the image illustrated in FIG. 19 is transmitted will be described. The image to be transmitted illustrated in FIG. 19 is the same image as the image described with reference to FIG. 8. The ROI regions #1 and #2 are set in the image to be transmitted. The line L1 includes pixels constituting the ROI region #2 in a section from the position P1 to the position P2.

In this case, for example, a value of 0100 is set as the value of the Data ID, and a value of 1 is set as the value of the Data mode. A value of the Data mode of 1 represents that the gradation of the pixel is partially switched.

Furthermore, a value representing that the number of ROI regions is one is set as the value of the Data_ROI_Num. A value representing the X coordinate of the position P1 in FIG. 19 is set as the value of the Data ROI start 1, and a value representing the width corresponding to a distance from the position P1 to the position P2 in FIG. 19 is set as the value of the Data ROI width 1.

As illustrated in the lower part of FIG. 19, in the payload, the Type 2 data is partially stored in a section corresponding to the section from the position P1 to the position P2, and the Type 1 data is stored in other sections.

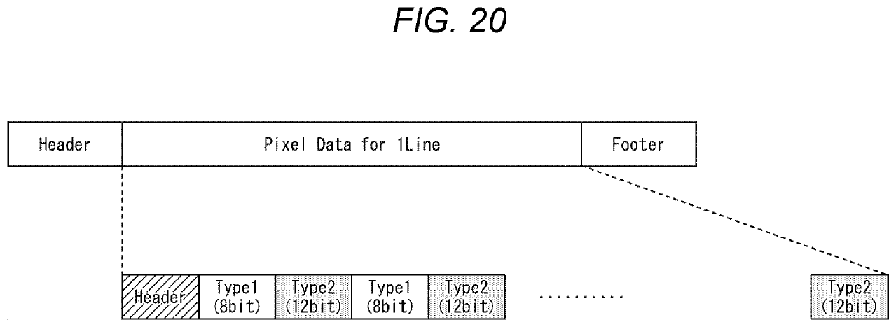

FIG. 20 is a diagram illustrating an example of storage of the separation information.

As illustrated in FIG. 20, it is also possible to store a part of the separation information at the beginning of the payload.

For example, in a case where the multi-gradation transmission method is applied to the ROI sensor system, it is possible that the Data ROI start and the Data ROI width cannot be stored in the header depending on the number of ROI regions. Since the Data ROI start and the Data ROI width are information set for each ROI region, in a case where the number of ROI regions included in the line to be transmitted is large, the data amounts of the Data ROI start and the Data ROI width may exceed the data amount of the empty region of the header.

As illustrated in FIG. 20, by using the beginning of the payload to store a part of the separation information, the information regarding each ROI region can be transmitted even in a case where the number of ROI regions included in the line to be transmitted is large.

### Configuration of Transmission Unit and Reception Unit

Configuration of Transmission Unit

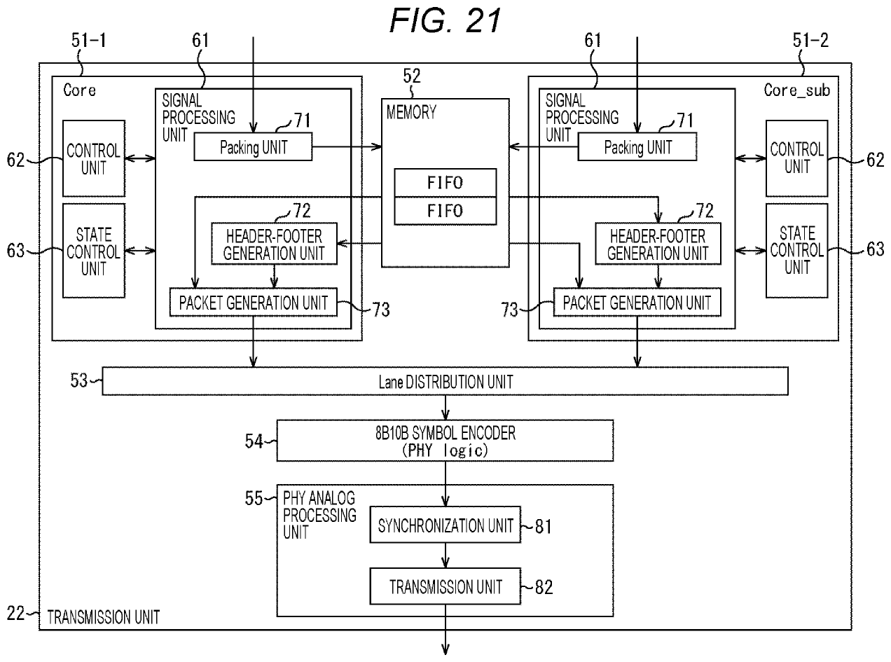

FIG. 21 is a block diagram illustrating a configuration example of the transmission unit 22.

As illustrated in FIG. 21, the transmission unit 22 includes a Core 51-1, a Core_sub 51-2, a memory 52, a Lane distribution unit 53, an 8B10B symbol encoder 54, and a PHY analog processing unit 55.

For example, a stream of a first system output from the information processing unit 21 is input to the Core 51-1, and a stream of a second system is input to the Core_sub 51-2. The Core 51-1 and Core_sub 51-2 are signal processing circuits that process a signal supplied from the outside.

The Core 51-1 includes a signal processing unit 61, a control unit 62, and a state control unit 63. The signal processing unit 61 includes a Packing unit 71, a header-footer generation unit 72, and a packet generation unit 73.

The Packing unit 71 of the signal processing unit 61 generates data (unit data having a predetermined bit width) of a pixel having a predetermined bit width by dividing data constituting a stream supplied from the outside into pieces of data having a predetermined bit width in units of eight bits, 12 bits, or the like. The Packing unit 71 outputs data of each pixel to the memory 52 to have the data stored.

The header-footer generation unit 72 refers to the data stored in the memory 52, and generates the separation information according to the storage pattern of data of each pixel in the payload. The header-footer generation unit 72 generates a header including the separation information, outputs the header to the packet generation unit 73, and appropriately outputs a footer including predetermined information to the packet generation unit 73.

The packet generation unit 73 reads data of pixels stored in the memory 52, and generates a payload by storing the data of each pixel according to the storage pattern. The packet generation unit 73 generates a packet by adding the header generated by the header-footer generation unit 72, and the like to the payload, and outputs the packet to the Lane distribution unit 53.

The control unit 62 controls the entire processing in the signal processing unit 61. For example, the storage pattern of data of each pixel in the payload generated by the header-footer generation unit 72 is controlled by the control unit 62.

The state control unit 63 controls the state of the signal processing unit 61. Each processing of the signal processing unit 61 is performed according to the state set by the state control unit 63.

The Core_sub 51-2 has a configuration similar to that of the Core 51-1. In the Core_sub 51-2, processing similar to the processing performed in the Core 51-1 is performed for the stream of the second system supplied from the outside.

The memory 52 includes, for example, a static random access memory (SRAM), and functions as a shared FIF0 of the Core 51-1 and the Core_sub 51-2. The data of each pixel stored in the memory 52 is read in the order of storage.

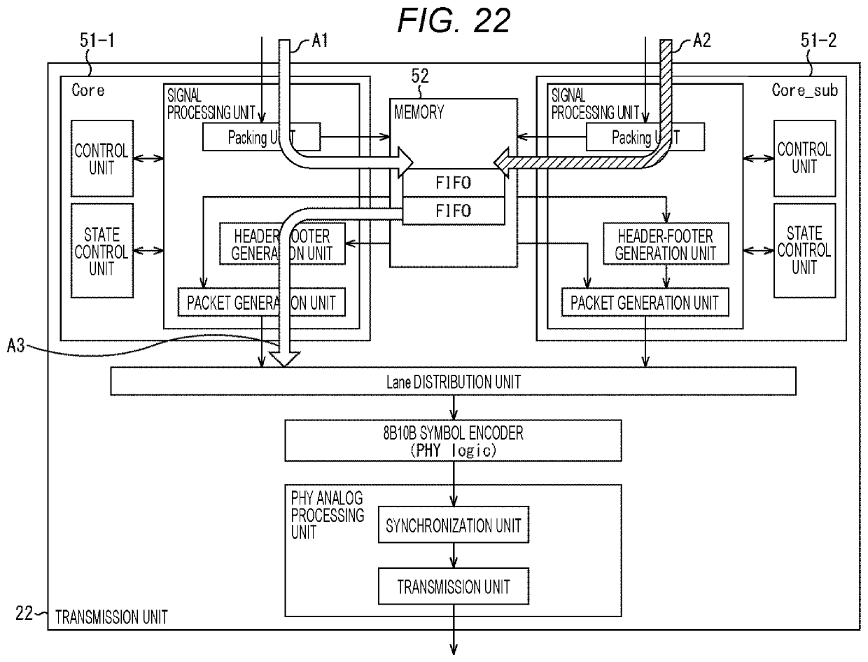

FIG. 22 is a diagram illustrating an example of data transmission.

A case where streams of two systems supplied from the information processing unit 21 are transmitted as indicated by arrows A1 and A2 in FIG. 22 will be described.

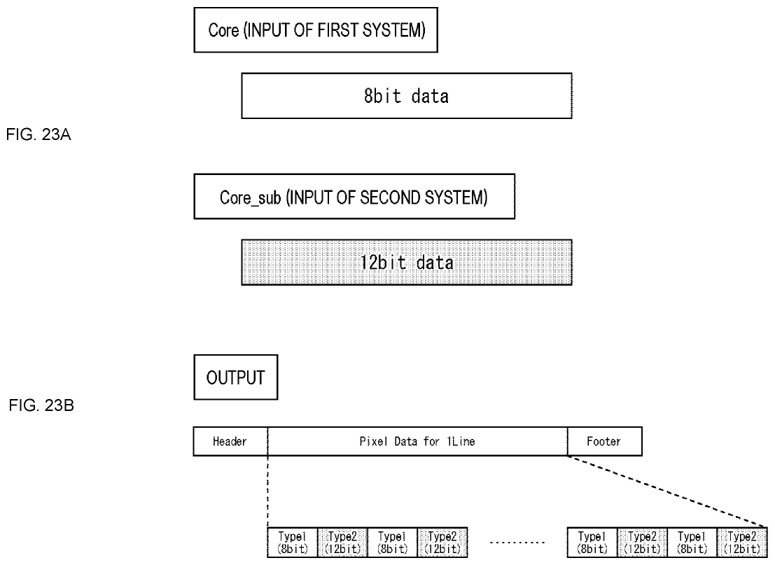

For example, in the Multi-camera system, streams of two systems output from the information processing unit 21 including a plurality of image sensors are input to the transmission unit 22. As illustrated in A of FIG. 23, the stream of the first system input to the Core 51-1 is data of eight-bit pixels. Furthermore, as illustrated in B of FIG. 23, the stream of the second system input to the Core_sub 51-2 is data of 12-bit pixels.

The stream of the first system including the data of eight-bit pixels is stored in the memory 52 through processing in the Packing unit 71 of the Core 51-1. Furthermore, the stream of the second system including data of 12-bit pixels is stored in the memory 52 through processing in the Packing unit 71 of the Core_sub 51-2.

In a case where streams of two systems are collectively transmitted as a stream of one system, data stored in the memory 52 is sequentially read by the Core 51-1 as indicated by arrow A3 in FIG. 22. Furthermore, in the Core 51-1, a packet of the multi-gradation transmission method as illustrated in B of FIG. 23 in which data of pixels of a plurality of gradations is stored in one payload is generated.

In the payload of the packet illustrated in B of FIG. 23, data of eight-bit pixels and data of 12-bit pixels are stored according to the same storage pattern as the storage pattern described with reference to FIG. 4.

Thus, in a case where streams of two systems are collectively transmitted as a stream of one system in the Multi-camera system, only one of the output of the Core 51-1 and the output of the Core_sub 51-2 is used. The packet in which the data of pixels of the plurality of gradations is stored in the payload is supplied from the Core 51-1 to the Lane distribution unit 53.

Returning to the description of FIG. 21, in a case where the packet is supplied from the packet generation unit 73 of the Core 51-1, the Lane distribution unit 53 distributes data constituting the packet to a plurality of lanes and outputs data of respective lanes to the 8B10B symbol encoder 54 in parallel.

In a case where the packet is supplied from the packet generation unit 73 of the Core_sub 51-2, similarly, the Lane distribution unit 53 distributes data constituting the packet to a plurality of lanes and outputs data of respective lanes to the 8B10B symbol encoder 54 in parallel.

Processing of the 8B10B symbol encoder 54 and the PHY analog processing unit 55, which is processing of the physical layer, is performed in parallel for each lane.

The 8B10B symbol encoder 54 performs 8B10B conversion on the data supplied from the Lane distribution unit 53, and outputs the data to the PHY analog processing unit 55 as data in units of 10 bits.

The synchronization unit 81 of the PHY analog processing unit 55 synchronizes the data of respective lanes and outputs the data to the transmission unit 82.

The transmission unit 82 outputs the data of respective lanes supplied from the synchronization unit 81 to the transmission line. The data output from the transmission unit 82 to the transmission line is received by the reception unit 31.

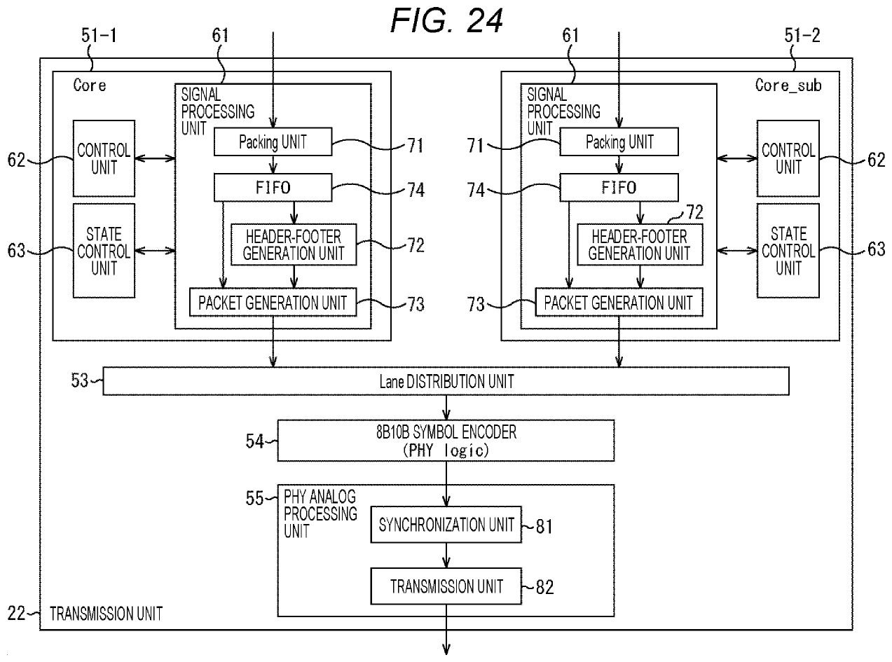

FIG. 24 is a block diagram illustrating another configuration example of the transmission unit 22.

The configuration of the transmission unit 22 illustrated in FIG. 24 is different from the configuration of FIG. 21 in that each of the Core 51-1 and the Core_sub 51-2 includes a FIFO. Among components illustrated in FIG. 24, the same components as those described above are denoted by the same reference numerals. Duplicate descriptions will be omitted as appropriate.

The Packing unit 71 of the signal processing unit 61 constituting the Core 51-1 generates data of pixels having a predetermined bit width by dividing data constituting a stream supplied from the outside into pieces of data having a predetermined bit width. The Packing unit 71 outputs data of each pixel to a FIF0 74 to have the data stored.

The header-footer generation unit 72 refers to data stored in the FIF0 74, and generates separation information according to the storage pattern of data of each pixel in the payload. The header-footer generation unit 72 generates a header including the separation information, outputs the header to the packet generation unit 73, and appropriately outputs a footer including predetermined information to the packet generation unit 73.

The packet generation unit 73 reads data of pixels stored in the FIF0 74 and stores the data of each pixel according to the storage pattern, thereby generating a payload. The packet generation unit 73 generates a packet by adding the header generated by the header-footer generation unit 72, and the like to the payload, and outputs the packet to the Lane distribution unit 53.

The Core_sub 51-2 has a configuration similar to that of the Core 51-1. In the Core_sub 51-2, processing similar to the processing performed in the Core 51-1 is performed for the stream of the second system supplied from the outside.

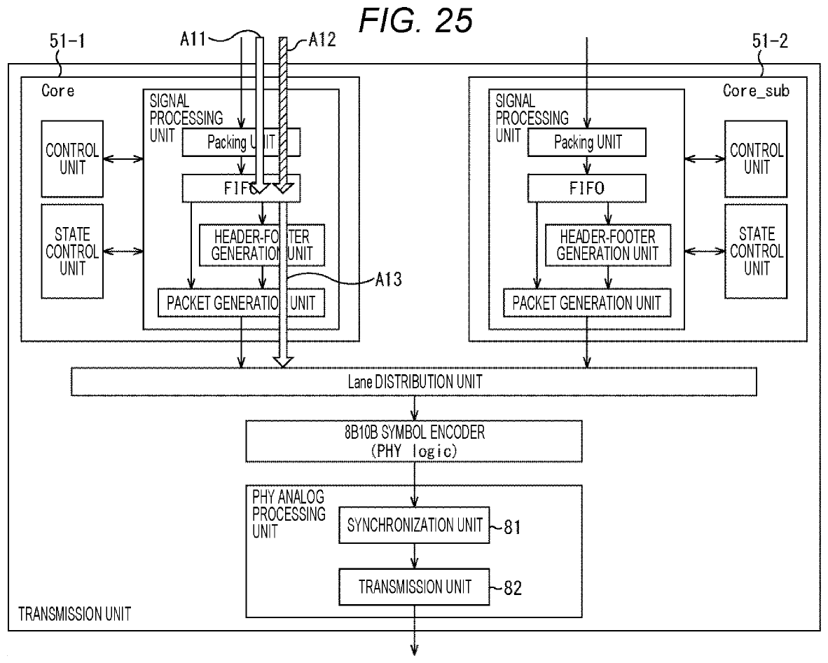

FIG. 25 is a diagram illustrating another example of data transmission.

As indicated by arrows A11 and A12 in FIG. 25, a case of transmitting a stream of one system supplied from the information processing unit 21 will be described. Arrows A11 and A12 indicate that data having different gradations is supplied as a stream of one system.

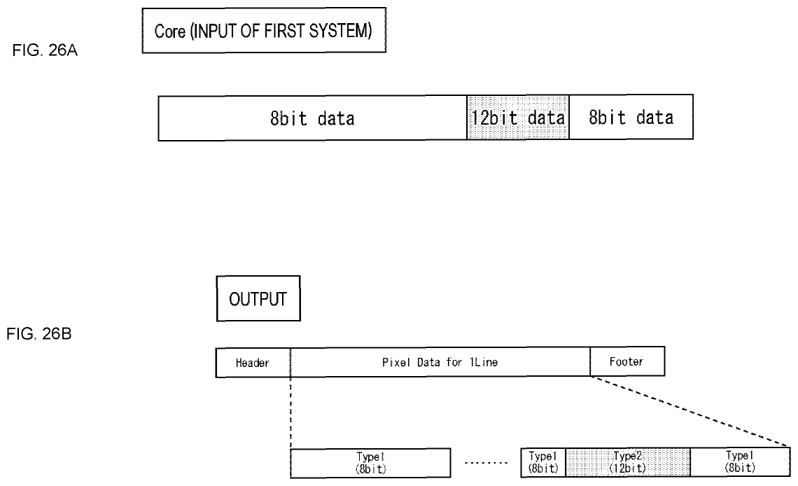

For example, in the ROI sensor system, data of pixels constituting the ROI region and data of pixels constituting the non-ROI region are input to the transmission unit 22 as a stream of one system as illustrated in A of FIG. 26. The data constituting the stream illustrated in A of FIG. 26 is data of one line including the pixels constituting the ROI region and the pixels constituting the non-ROI region described with reference to FIG. 19.

The stream of one system including data of eight-bit pixels and the data of 12-bit pixels is stored in the FIF0 74 through processing in the Packing unit 71 of the Core 51-1.

The data stored in the FIF0 74 is sequentially read by the packet generation unit 73 as indicated by arrow A13. Furthermore, a packet of the multi-gradation transmission method as illustrated in B of FIG. 26 in which data of pixels of a plurality of gradations is stored in one payload is generated.

In the payload of the packet illustrated in B of FIG. 26, data of eight-bit pixels and data of 12-bit pixels are stored according to the same storage pattern as the storage pattern described with reference to FIG. 12.

Thus, for example, the configuration of FIG. 25 is used in an application that transmits the stream of one system input from the outside. Furthermore, in an application that transmits streams of two systems input from the outside, for example, the configuration of FIG. 21 is used.

Configuration of Reception Unit

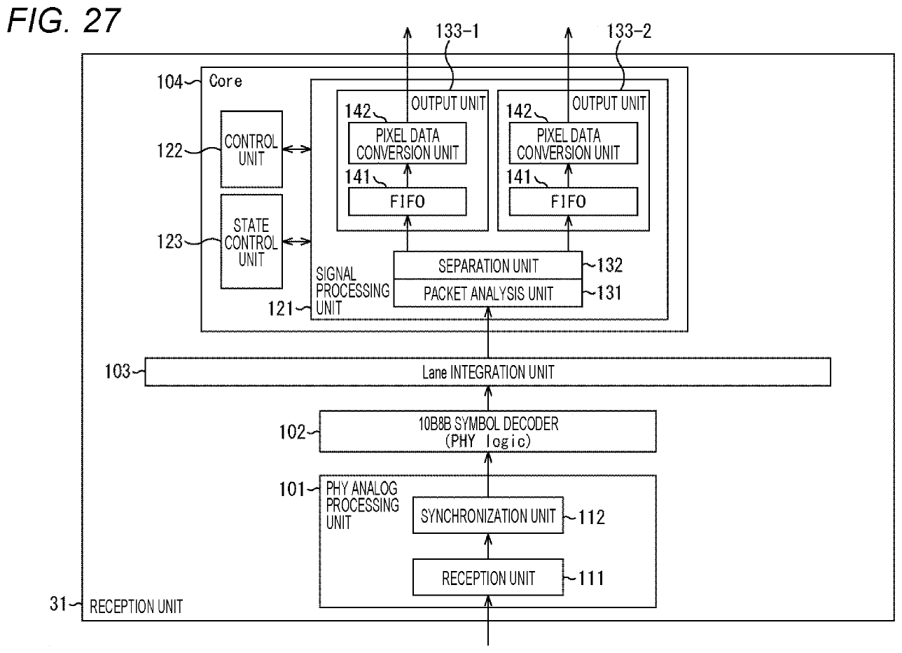

FIG. 27 is a block diagram illustrating a configuration example of the reception unit 31.

As illustrated in FIG. 27, the reception unit 31 includes a PHY analog processing unit 101, a 10B8B symbol decoder 102, a Lane integration unit 103, and a Core 104. Data output from the transmission unit 22 to the transmission line is input to the PHY analog processing unit 101.

Processing of the PHY analog processing unit 101 and the 10B8B symbol decoder 102, which is processing of the physical layer, is performed in parallel for each lane.

The reception unit 111 of the PHY analog processing unit 101 receives a signal for each lane representing data of a packet transmitted from the transmission unit 22 via the transmission line, and outputs the signal to the synchronization unit 112.

The synchronization unit 112 performs bit synchronization by detecting an edge of the signal supplied from the reception unit 111, and generates a clock signal on the basis of detection periods of edges. Furthermore, the synchronization unit 112 samples the signal received by the reception unit 111 according to the generated clock signal, and outputs data of a packet obtained by the sampling to the 10B8B symbol decoder 102.

The 10B8B symbol decoder 102 performs 10B8B conversion on the data supplied from the synchronization unit 112, and outputs the data as eight-bit unit data to the Lane integration unit 103.

The Lane integration unit 103 integrates the data of respective lanes supplied from the 10B8B symbol decoder 102 by rearranging the data in the reverse order of the distribution order to the respective lanes by the Lane distribution unit 53 (FIG. 21) of the transmission unit 22. The Lane integration unit 103 outputs the data of an integrated packet to the Core 104.

The Core 104 includes a signal processing unit 121, a control unit 122, and a state control unit 123. The signal processing unit 121 includes a packet analysis unit 131, a separation unit 132, and output units 133-1 and 133-2.

The packet analysis unit 131 of the signal processing unit 121 receives the data of the packet supplied from the Lane integration unit 103 and analyzes the packet. For example, the packet analysis unit 131 outputs data of the payload constituting a packet to the separation unit 132 and analyzes the header. The packet analysis unit 131 outputs information representing the switching position of gradation and the like to the separation unit 132 on the basis of the separation information included in the header.

The separation unit 132 separates data of pixels of respective gradations stored in the payload on the basis of the switching position of gradation represented by the information supplied from the packet analysis unit 131, and the like. The separation unit 132 distributes the separated data of pixels according to the gradations such as outputting data of eight-bit pixels to the output unit 133-1 and outputting data of 12-bit pixels to the output unit 133-2.

A FIF0 141 of the output unit 133-1 stores the data supplied from the separation unit 132. The data stored in the FIF0 141 is read by the pixel data conversion unit 142 in the order of storage.

The pixel data conversion unit 142 converts the data read from the FIF0 141 into data of pixels of eight-bit gradations and outputs the data.

The output unit 133-2 has a configuration similar to that of the output unit 133-1. In the output unit 133-2, processing similar to the processing performed in the output unit 133-1 is performed for the data supplied from the separation unit 132. The data of 12-bit pixels is output from the pixel data conversion unit 142 of the output unit 133-2.

The control unit 122 controls the entire processing in the Core 104.

The state control unit 123 controls the state of the Core 104. Each processing of the Core 104 is performed according to the state set by the state control unit 123.

### Operation of Transmission Unit and Reception Unit

Operations of the transmission unit 22 and the reception unit 31 having the configurations as above will be described.

Operation of Transmission Unit

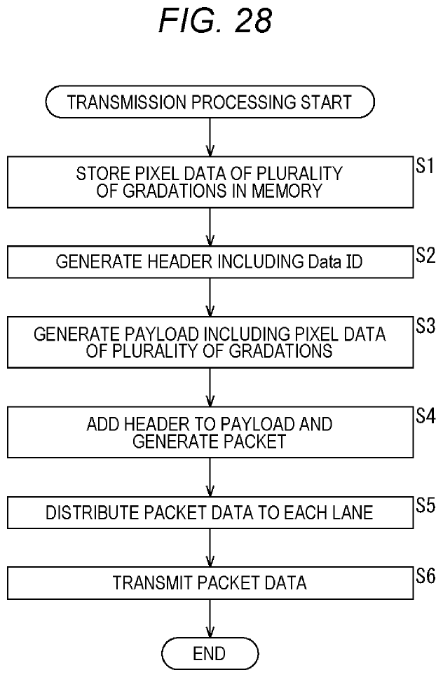

First, processing of the transmission unit 22 that transmits data by the multi-gradation transmission method will be described with reference to a flowchart of FIG. 28.

The processing of FIG. 28 is started, for example, when the stream of the first system output from the information processing unit 21 is input to the Core 51-1 and the stream of the second system is input to the Core_sub 51-2.

In step S1, data of pixels of a plurality of gradations is stored in the memory 52. That is, the Packing unit 71 of the signal processing unit 61 constituting the Core 51-1 outputs, for example, data of eight-bit pixels to the memory 52 to have the data stored. Furthermore, the Packing unit 71 of the signal processing unit 61 constituting the Core_sub 51-2 outputs, for example, data of 12-bit pixels to the memory 52 to have the data stored.

In step S2, the header-footer generation unit 72 generates a header including the separation information such as the Data ID according to the storage pattern of the data of respective pixels.

In step S3, the packet generation unit 73 reads the data of pixels stored in the memory 52 and stores the data of respective pixels according to the storage pattern, thereby generating a payload in which the data of pixels of the plurality of gradations is stored.

In step S4, the packet generation unit 73 generates a packet by adding the header or the like generated by the header-footer generation unit 72 to the payload.

In step S5, the Lane distribution unit 53 distributes the data constituting the packet supplied from the packet generation unit 73 of the Core 51-1 to a plurality of lanes and outputs the data.

In step S6, the PHY analog processing unit 55 performs processing of the physical layer on the data of respective lanes, and transmits the data of respective lanes from the transmission unit 82.

The above processing is repeatedly performed for each line constituting one frame.

Operation of Reception Unit

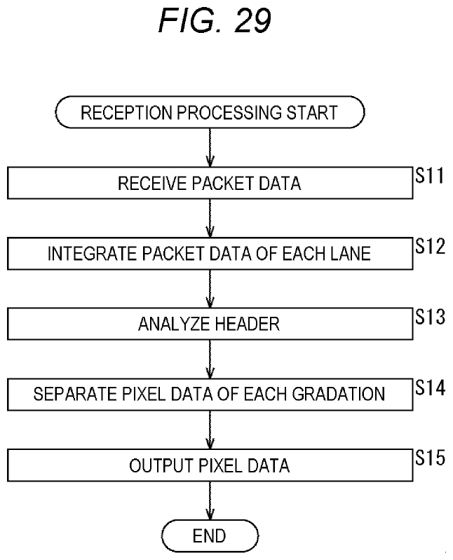

Next, processing of the reception unit 31 that receives data transmitted by the multi-gradation transmission method will be described with reference to a flowchart of FIG. 29.

The processing of FIG. 29 is started, for example, when a signal for each lane representing the data of the packet transmitted from the transmission unit 22 is supplied.

In step S11, the PHY analog processing unit 101 performs synchronization of the signals received by the reception unit 111 to receive packet data, or the like.

In step S12, the Lane integration unit 103 integrates the data of each lane supplied from the 10B8B symbol decoder 102 of the PHY analog processing unit 101.

In step S13, the packet analysis unit 131 of the signal processing unit 121 receives the data of the packet supplied from the Lane integration unit 103 and analyzes the header. By analyzing the separation information, a switching position of gradation and the like are specified.

In step S14, the separation unit 132 separates the data of pixels of respective gradations stored in the payload on the basis of an analysis result of the header by the packet analysis unit 131. For example, data of eight-bit pixels is output from the separation unit 132 to the output unit 133-1. Furthermore, for example, data of 12-bit pixels is output from the separation unit 132 to the output unit 133-2.

In step S15, the pixel data conversion unit 142 of the output unit 133-1 converts the data read from the FIF0 141 into data of pixels of eight-bit gradations and outputs the data. Furthermore, the pixel data conversion unit 142 of the output unit 133-2 converts the data read from the FIF0 141 into data of pixels of 12-bit gradations and outputs the data.

The above processing is repeatedly performed while the packet storing the data of pixels of each line is transmitted from the transmission unit 22.

### Example of Another Application

Although the case of transmitting the data of pixels has been described above, the multi-gradation transmission method can be used for transmission of various types of data other than the data of pixels.

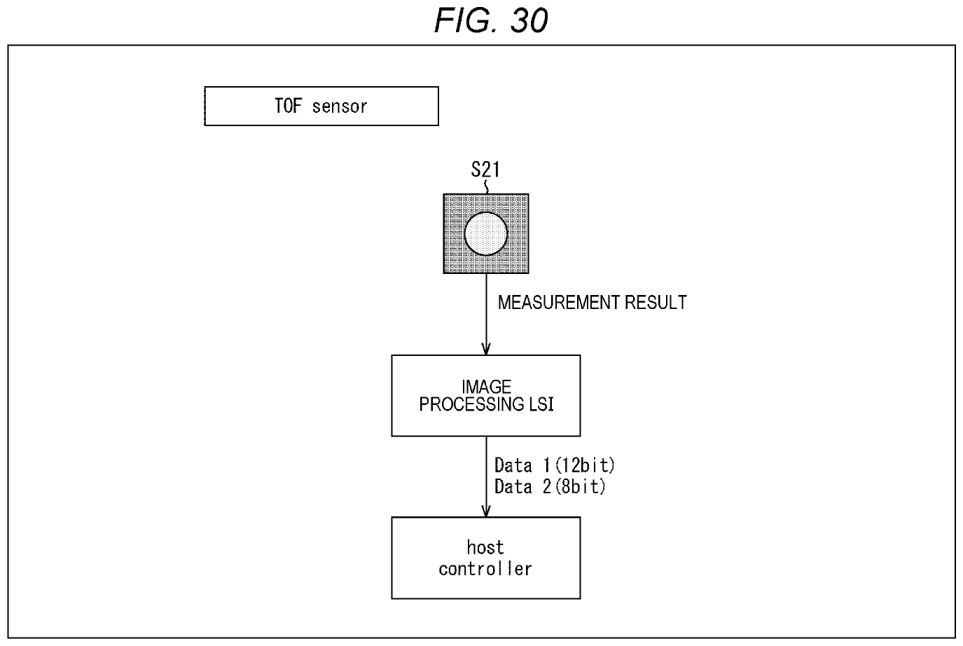

FIG. 30 is a diagram illustrating an example of a Time of Flight (TOF) sensor system.

The TOF sensor system is a system that measures a distance to an object by detecting reflected light of light emitted from a light source.

In the example of FIG. 30, information representing a measurement result is output from the TOF sensor S21 and input to the information processing LSI. The measurement result includes, for example, calibration information that is information representing a value used for calibration, and histogram information that is information representing a target histogram.

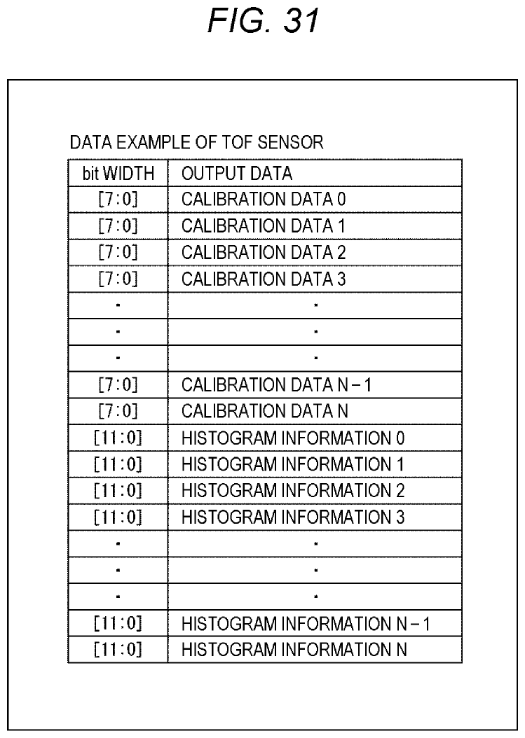

FIG. 31 is a diagram illustrating an example of a format of output data of the TOF sensor S21.

As illustrated in FIG. 31, predetermined numbers of pieces of calibration information and histogram information are output from the TOF sensor S21 as output data. In the example of FIG. 31, one piece of output data includes N+1 pieces of calibration information and histogram information. The bit width of the calibration information is eight bits, and the bit width of the histogram information is 12 bits.

That is, the output data of the TOF sensor S21 includes data of a plurality of items having different bit widths. Output data having such a predetermined format is output from the TOF sensor S21 every time measurement is performed.

In the information processing LSI, a packet in which the entire output data supplied from the TOF sensor S21 is stored in one payload as one line of data is generated and transmitted to the host controller.

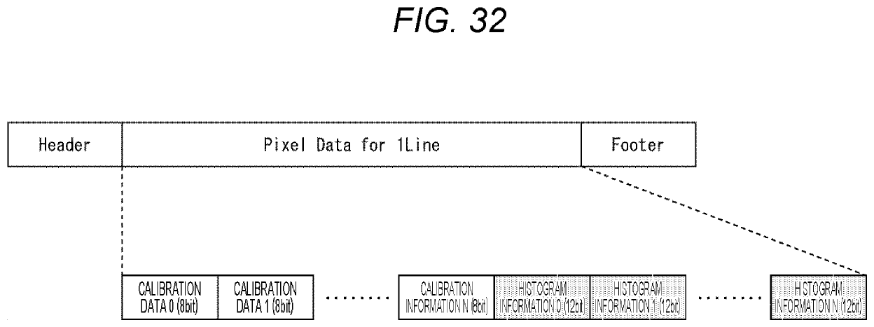

FIG. 32 is a diagram illustrating a configuration example of a packet.

As illustrated in FIG. 32, N+1 pieces of calibration information are continuously stored in the payload of the packet, and subsequently N+1 pieces of histogram information are continuously stored.

That is, in the payload of one packet illustrated in FIG. 32, a plurality of types of unit data having different bit widths for each data unit is stored with data of one item representing a measurement result as unit data.

Thus, in a case where the data to be transmitted has a predetermined format and a plurality of items having different bit widths is included in the format, the transmission unit 22 can store the entire data of the plurality of items in one payload and transmit the data by the multi-gradation transmission method.

Note that in a case where the TOF sensor system is implemented in the configuration of the transmission system 1 in FIG. 1, for example, the function of the TOF sensor S21 is implemented by the information processing unit 21, and the function of the image processing LSI is implemented by the transmission unit 22. The function of the host controller is implemented by the reception unit 31 and the information processing unit 32.

By applying the multi-gradation transmission method to the TOF sensor system, information of a plurality of items having different bit widths can be efficiently transmitted.

### SLVS-EC Standard

Here, the SLVS-EC standard will be described.

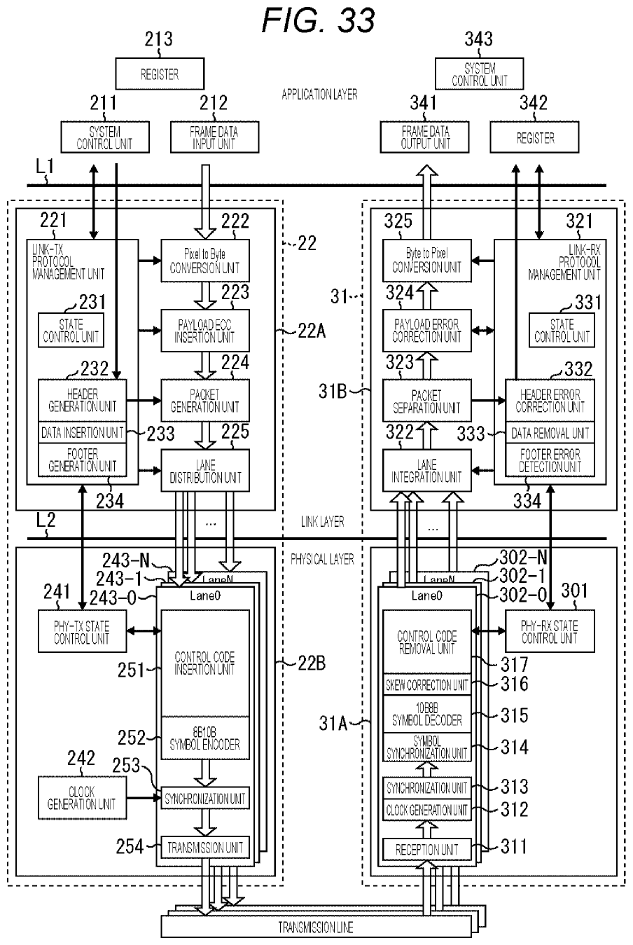

FIG. 33 is a diagram illustrating a detailed configuration example of the transmission unit 22 and the reception unit 31.

A configuration indicated by enclosing with a dashed line on the left side of FIG. 33 is a configuration of the transmission unit 22, and a configuration indicated by enclosing with a dashed line on the right side is a configuration of the reception unit 31. The transmission unit 22 and the reception unit 31 each have a configuration of the link layer and a configuration of the physical layer. In each layer of the transmission unit 22 and the reception unit 31, various processes other than the above-described processes are actually performed.

A configuration illustrated above a solid line L2 is a configuration of the link layer, and a configuration illustrated below the solid line L2 is a configuration of the physical layer. In the transmission unit 22, a configuration illustrated above the solid line L2 is a configuration to perform signal processing of the link layer, and a configuration illustrated below the solid line L2 is a configuration to perform signal processing of the physical layer.

Furthermore, in the reception unit 31, a configuration illustrated below the solid line L2 is a configuration to perform signal processing of the physical layer, and a configuration illustrated above the solid line L2 is a configuration to perform signal processing of the link layer.

Note that a configuration illustrated above the solid line L1 is a configuration of the application layer. A system control unit 211, a frame data input unit 212, and a register 213 are implemented, for example, in the information processing unit 21.

The system control unit 211 communicates with a LINK-TX protocol management unit 221 of the transmission unit 22 and controls transmission of image data by providing information regarding the frame format and the like.

The frame data input unit 212 supplies data of respective pixels constituting the image to be transmitted to the Pixel to Byte conversion unit 222 of the transmission unit 22.

The register 213 stores information such as the bit depth and the number of Lanes for Pixel to Byte conversion. Transmission processing of image data is performed according to the information stored in the register 213.

Furthermore, a frame data output unit 341, a register 342, and a system control unit 343 in the configuration of the application layer are implemented in the information processing unit 32.

The frame data output unit 341 generates and outputs an image of one frame on the basis of the pixel data of each line supplied from the reception unit 31. Various processes are performed using the image output from the frame data output unit 341.

The register 342 stores various set values related to reception of image data, such as the bit depth and the number of Lanes for Byte to Pixel conversion. Reception processing of image data is performed according to information stored in the register 342.

The system control unit 343 communicates with the LINK-RX protocol management unit 321 and controls a sequence such as a mode change.

Configuration of Link Layer of Transmission Unit 22

First, the configuration of the link layer of the transmission unit 22 will be described.

A link layer processing unit 22A of the transmission unit 22 is provided with a LINK-TX protocol management unit 221, a Pixel to Byte conversion unit 222, a payload ECC insertion unit 223, a packet generation unit 224, and a lane distribution unit 225 as the configuration of the link layer. The LINK-TX protocol management unit 221 includes a state control unit 231, a header generation unit 232, a data insertion unit 233, and a footer generation unit 234.

For example, the Pixel to Byte conversion unit 222 corresponds to the Packing unit 71 in FIG. 21. The packet generation unit 224 corresponds to the packet generation unit 73 in FIG. 21. The lane distribution unit 225 corresponds to the lane distribution unit 53 in FIG. 21. The header generation unit 232 and the footer generation unit 234 correspond to the header-footer generation unit 72 in FIG. 21. That is, the configuration illustrated in FIG. 21 and the like is a configuration in which the configuration of the transmission unit 22 is simplified.

The state control unit 231 of the LINK-TX protocol management unit 221 manages the state of the link layer of the transmission unit 22.

The header generation unit 232 generates the header to be added to the payload in which pixel data for one line is stored, and outputs the header to the packet generation unit 224.

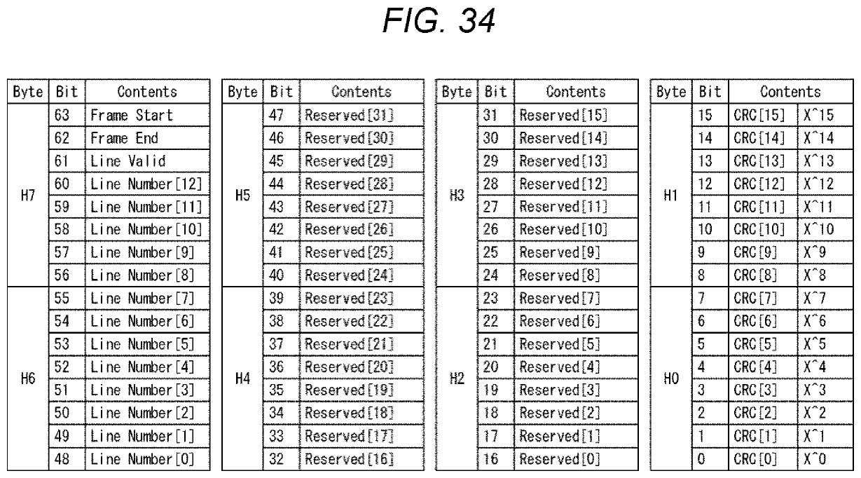

FIG. 34 is a diagram illustrating an example of an eight-byte bit array that constitutes one set of header information and CRC code.

A byte H7, which is a first one byte of the eight bytes constituting the header, includes one bit each of the Frame Start, the Frame End, and the Line Valid, and the first to fifth bits among 13 bits of the Line Number, in order from the first bit. Furthermore, a byte H6, which is a second one byte, includes the sixth to 13th bits among the 13 bits of the Line Number.

A byte H5, which is a third one byte, to a byte H2, which is a sixth one-byte, are Reserved. In the multi-gradation transmission method, the separation information and the like are described using the Reserved area. A byte H1, which is a seventh one byte, and a byte H0, which is an eighth one byte, include each bit of the CRC code.

Returning to the description of FIG. 33, the header generation unit 232 generates header information according to control by the system control unit 211. For example, the system control unit 211 supplies information representing a line number of pixel data output by the frame data input unit 212 and information representing the beginning and end of a frame.

Furthermore, the header generation unit 232 applies the header information to a generation polynomial to calculate the CRC code. The generation polynomial of the CRC code to be added to the header information is expressed by, for example, following Equation (1).

[Equation 1]

CRC16=X¹⁶+X¹⁵+X²+1 (1)

The header generation unit 232 generates a set of header information and a CRC code by adding the CRC code to the header information, and generates the header by repeatedly arranging three sets of the same header information and CRC code. The header generation unit 232 outputs the generated header to the packet generation unit 224.

The data insertion unit 233 generates data used for stuffing and outputs the data to the Pixel to Byte conversion unit 222 and the lane distribution unit 225. Payload stuffing data, which is stuffing data supplied to the Pixel to Byte conversion unit 222, is added to pixel data after the Pixel to Byte conversion and is used for adjusting the data amount of pixel data stored in the payload. Furthermore, lane stuffing data, which is stuffing data supplied to the lane distribution unit 225, is added to data after lane assignment and used for adjusting the amount of data between lanes.

The footer generation unit 234 calculates a 32-bit CRC code by appropriately applying payload data to the generation polynomial according to control by the system control unit 211, and outputs the CRC code obtained by calculation as a footer to the packet generation unit 224. The CRC code generation polynomial added as a footer is expressed by, for example, following Equation (2).

[Equation 2]

CRC32=X³²+X³¹+X⁴+X³+X+1 (2)

The Pixel to Byte conversion unit 222 acquires pixel data supplied from the frame data input unit 212, and performs Pixel to Byte conversion that converts the data of each pixel into data in one-byte units. For example, the pixel value (RGB) of each pixel of the image is represented by the bit depth of any one of eight bits, 10 bits, 12 bits, 14 bits, and 16 bits.

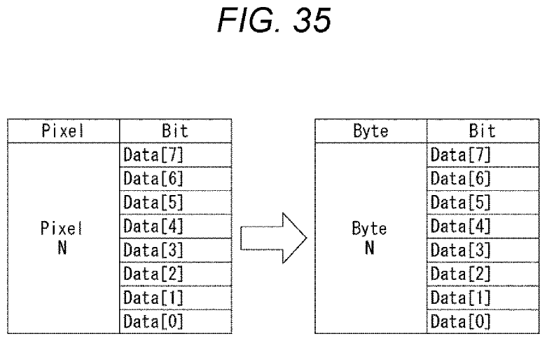

FIG. 35 is a diagram illustrating an example of the Pixel to Byte conversion in a case where the pixel value of each pixel is represented by eight bits.

Data[0] represents LSB, and Data[7] with the largest number represents MSB. As illustrated by a white arrow, in this case, eight bits of Data[7] to [0] representing a pixel value of pixel N are converted into a Byte N including Data[7] to [0]. In a case where the pixel value of each pixel is represented by eight bits, the number of pieces of data in byte units after the Pixel to Byte conversion is the same as the number of pixels.

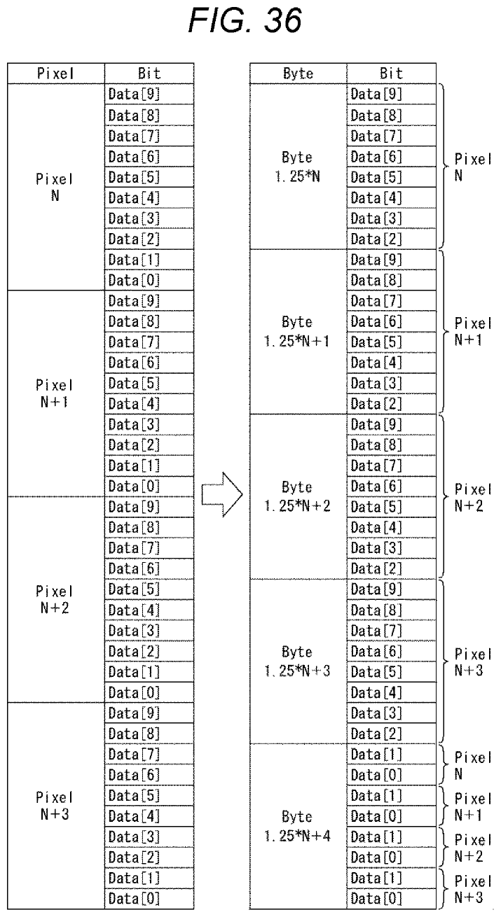

FIG. 36 is a diagram illustrating an example of the Pixel to Byte conversion in a case where the pixel value of each pixel is represented by 10 bits.

In this case, 10 bits of Data[9] to [0] representing a pixel value of pixel N are converted into Byte 1.25*N including Data[9] to [2].

For pixels N+1 to N+3, similarly, 10 bits of Data[9] to [0] representing respective pixel values are converted into Byte 1.25*N+1 to Byte 1.25*N+3 including Data[9] to [2]. Furthermore, Data[1] and Data[0], which are respective lower bits of pixels N to N+3, are collected and converted into Byte 1.25*N+4. In a case where the pixel value of each pixel is represented by 10 bits, the number of pieces of data in byte units after the Pixel to Byte conversion is 1.25 times the number of pixels.

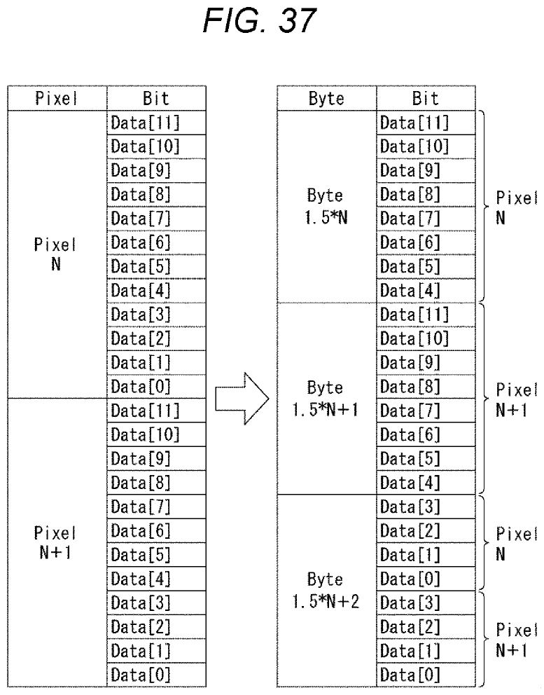

FIG. 37 is a diagram illustrating an example of the Pixel to Byte conversion in a case where the pixel value of each pixel is represented by 12 bits.

In this case, 12 bits of Data[11] to [0] representing a pixel value of pixel N are converted into Byte 1.5*N including Data[11] to [4].

For a pixel N+1, similarly, 12 bits of Data[11] to [0] representing a pixel value of pixel N+1 are converted into Byte 1.5*N+1 including Data[11] to [4]. Furthermore, Data[3] to [0], which are respective lower bits of pixel N and pixel N+1, are collected and converted into Byte 1.5*N+2. In a case where the pixel value of each pixel is represented by 12 bits, the number of pieces of data in byte units after the Pixel to Byte conversion is 1.5 times the number of pixels.

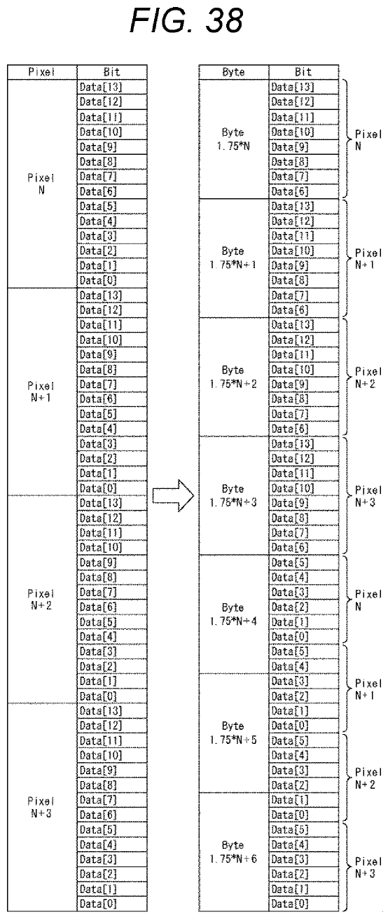

FIG. 38 is a diagram illustrating an example of the Pixel to Byte conversion in a case where the pixel value of each pixel is represented by 14 bits.

In this case, 14 bits of Data[13] to [0] representing a pixel value of pixel N are converted into Byte 1.75*N including Data[13] to [6].

For pixels N+1 to N+3, similarly, 14 bits of Data[13] to [0] representing respective pixel values are converted into Byte 1.75*N+1 to Byte 1.75*N+3 including Data[13] to [6]. Furthermore, the remaining bits of the bits of pixels N to N+3 are collected in order from the lower bit, and for example, Data[5] to [0], which are bits of pixel N, and Data[5] and [4], which are bits of pixel N+1, are converted into Byte 1.75*N+4.

Similarly, Data[3] to [0], which are bits of pixel N+1, and Data[5] to [2], which are bits of pixel N+2, are converted into Byte 1.75*N+5, and Data[1] and [0], which are bits of pixel N+2, and Data[5] to [0], which are bits of pixel N+3, are converted into Byte 1.75*N+6. In a case where the pixel value of each pixel is represented by 14 bits, the number of pieces of data in byte units after the Pixel to Byte conversion is 1.75 times the number of pixels.

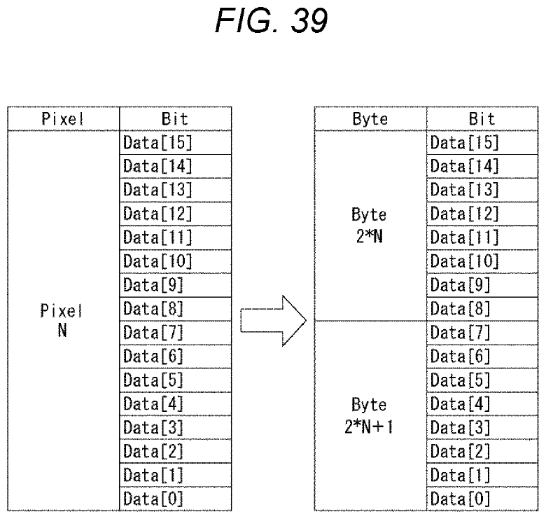

FIG. 39 is a diagram illustrating an example of the Pixel to Byte conversion in a case where the pixel value of each pixel is represented by 16 bits.

In this case, 16 bits of Data[15] to [0] representing a pixel value of pixel N are converted into Byte 2*N including Data[15] to [8] and Byte 2*N+1 including Data[7] to [0]. In a case where the pixel value of each pixel is represented by 16 bits, the number of pieces of data in byte units after the Pixel to Byte conversion is twice the number of pixels.

The Pixel to Byte conversion unit 222 of FIG. 33 performs such Pixel to Byte conversion for each pixel in order from, for example, the leftmost pixel of the line. Furthermore, the Pixel to Byte conversion unit 222 generates payload data by adding the payload stuffing data supplied from the data insertion unit 233 to the pixel data in byte units obtained by the Pixel to Byte conversion, and outputs the payload data to the payload ECC insertion unit 223.

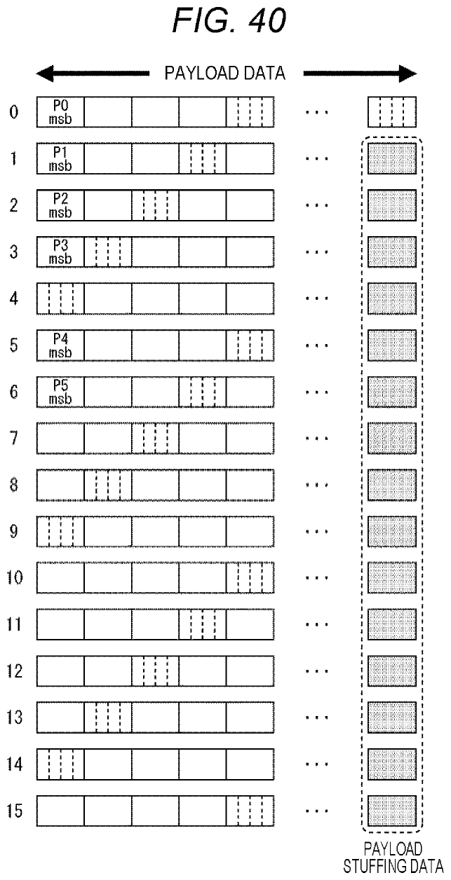

FIG. 40 is a diagram illustrating an example of the payload data.

FIG. 40 illustrates payload data including pixel data obtained by the Pixel to Byte conversion in a case where the pixel value of each pixel is represented by 10 bits. One uncolored block represents pixel data in byte units after the Pixel to Byte conversion. Furthermore, one colored block represents the payload stuffing data generated by the data insertion unit 233. Note that in the multi-gradation transmission method, payload data includes data of pixels of a plurality of gradations.

The pixel data after the Pixel to Byte conversion is grouped into a predetermined number of groups in the order obtained by the conversion. In the example of FIG. 40, each pixel data is grouped into 16 groups of groups 0 to 15, pixel data including MSB of pixel P0 is assigned to the group 0, and pixel data including MSB of pixel P1 is assigned to the group 1. Furthermore, pixel data including MSB of pixel P2 is assigned to the group 2, pixel data including MSB of pixel P3 is assigned to the group 3, and pixel data including LSB of pixels P0 to P3 is assigned to the group 4.

Pixel data including MSB of pixel P4 and pixel data thereafter are also assigned to respective groups of the group 5 and thereafter in order. When a certain pixel data is assigned to the group 15, pixel data thereafter is sequentially assigned to respective groups of the group 0 and thereafter. Note that among the blocks representing pixel data, blocks with three dashed lines added inside represent pixel data in byte units generated so as to include LSBs of pixels N to N+3 during the Pixel to Byte conversion.

In the link layer of the transmission unit 22, after grouping is performed in this manner, processing is performed in parallel for the pixel data at the same position in each group at every period defined by a clock signal. That is, in a case where pixel data is assigned to 16 groups as illustrated in FIG. 40, processing of pixel data proceeds so that 16 pieces of pixel data arranged in each column are processed within the same period.

As described above, the payload of one packet includes one line of pixel data. The entire pixel data illustrated in FIG. 40 is pixel data constituting one line. Here, the processing of pixel data in the effective pixel area A1 of FIG. 2 is described, but the pixel data in other areas such as the margin area A2 is also processed together with the pixel data in the effective pixel area A1.

After the pixel data for one line is grouped, the payload stuffing data is added so that respective data lengths of the groups are the same. The payload stuffing data is one byte of data.

In the example of FIG. 40, the payload stuffing data is not added to the pixel data of the group 0, and as indicated by enclosing with a dashed line, one payload stuffing data is added at the end of each piece of pixel data of the groups 1 to 15. The data length (Byte) of the payload data including pixel data and stuffing data is expressed by following Equation (3).

$$\begin{matrix}[ Equation 3 ] & \\ PayloadLength = LineLength \times \frac{BitPix}{8} + PayloadStuffing & ( 3 )\end{matrix}$$

LineLength in Equation (3) represents the number of pixels of a line, and BitPix represents the bit depth representing the pixel value of one pixel. PayloadStuffing represents the number of pieces of payload stuffing data.

In a case where pixel data is assigned to 16 groups as illustrated in FIG. 40, the number of pieces of payload stuffing data is expressed by following Equation (4). % in Equation (4) represents a remainder.

$$\begin{matrix}[ Equation 4 ] & \\ PayloadStuffing = 16 - ( ( LineLength \times \frac{BitPix}{8} ) \% 16 ) & ( 4 )\end{matrix}$$

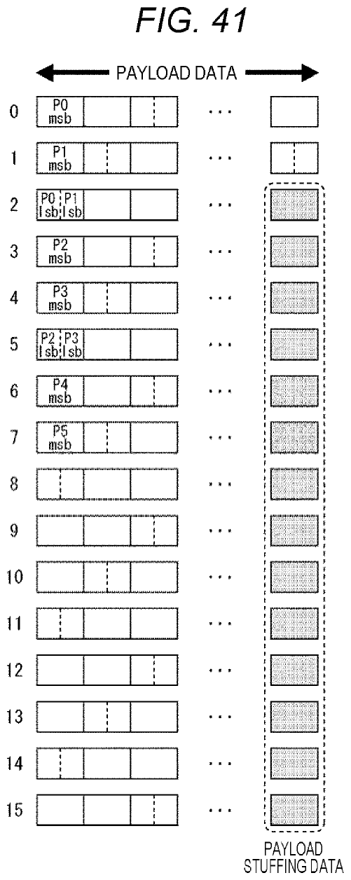

FIG. 41 is a diagram illustrating another example of the payload data.

FIG. 41 illustrates the payload data including pixel data obtained by the Pixel to Byte conversion in a case where the pixel value of each pixel is represented by 12 bits.

In the example of FIG. 41, pixel data including MSB of pixel P0 is assigned to a group 0, pixel data including MSB of pixel P1 is assigned to a group 1, pixel data including LSBs of pixel P0 and pixel P1 is assigned to a group 2. Pixel data including MSB of pixel P2 and pixel data thereafter are also assigned to respective groups of a group 3 and thereafter in order. Note that among the blocks representing pixel data, blocks with one dashed line added inside represent pixel data in byte units generated so as to include LSBs of pixel N and pixel N+1 during the Pixel to Byte conversion.

In the example of FIG. 41, payload stuffing data is not added to the pixel data of the group 0 and the group 1, and payload stuffing data is added one by one at the end of each pixel data of groups 2 to 15.

Payload data having such a configuration is supplied from the Pixel to Byte conversion unit 222 to the payload ECC insertion unit 223.

The payload ECC insertion unit 223 calculates an error correction code used for error correction of payload data on the basis of the payload data supplied from the Pixel to Byte conversion unit 222, and a parity that is the error correction code obtained by the calculation is inserted in the payload data. As the error correction code, for example, a Reed-Solomon code is used. Note that the insertion of the error correction code is an option, and for example, it is possible to only perform either of the insertion of the parity by the payload ECC insertion unit 223 and the addition of a footer by the footer generation unit 234.

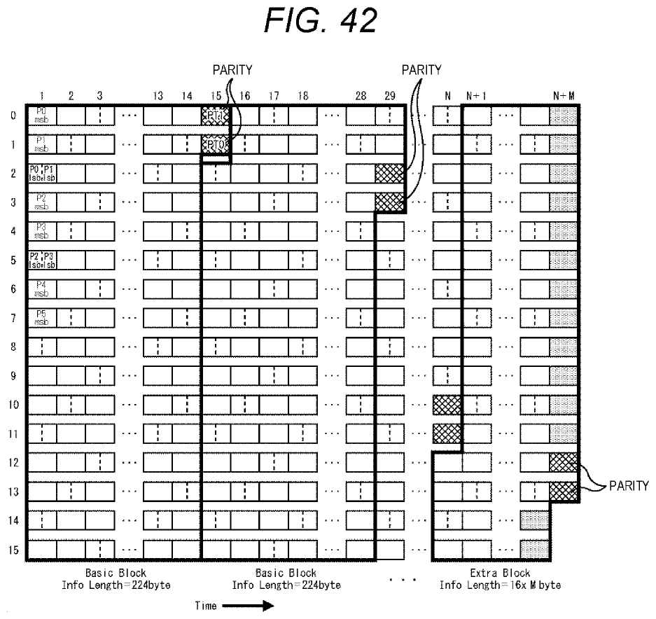

FIG. 42 is a diagram illustrating an example of payload data in which the parity is inserted.

The payload data illustrated in FIG. 42 is the payload data including the pixel data obtained by the Pixel to Byte conversion in a case where the pixel value of each pixel is represented by 12 bits, which is described with reference to FIG. 41. The shaded blocks represent the parity.

In the example of FIG. 42, 14 pixels are selected in order from first pixel data of each group of groups 0 to 15, and a two-byte parity is obtained on the basis of the selected 224 pieces (224 bytes) of pixel data. The two-byte parity is inserted as 15th data in groups 0 and 1 following the 224 pieces of pixel data used in the calculation, and a first Basic Block includes the 224 pieces of pixel data and a two-byte parity.

Thus, in the payload ECC insertion unit 223, basically, the two-byte parity is generated on the basis of the 224 pieces of pixel data, and inserted following the 224 pieces of pixel data.

Furthermore, in the example of FIG. 42, 224 pieces of pixel Data following the first Basic Block are selected in order from each group, and a two-byte parity is obtained on the basis of the selected 224 pieces of pixel data. The two-byte parity is inserted as 29th data in the groups 2 and 3 following the 224 pieces of pixel data used in the calculation, and a second Basic Block includes the 224 pieces of pixel data and the two-byte parity.

In a case where 16×M, which is the number of pieces of pixel data and payload stuffing data following a certain Basic Block, is less than 224, then the two-byte parity is obtained on the basis of the remaining 16×M blocks (pixel data and payload stuffing data). Furthermore, the obtained two-byte parity is inserted following the payload stuffing data, and an Extra Block includes 16×M blocks and the two-byte parity.

The payload ECC insertion unit 223 outputs the payload data with a parity inserted to the packet generation unit 224. In a case where the parity is not inserted, the payload data supplied from the Pixel to Byte conversion unit 222 to the payload ECC insertion unit 223 is output to the packet generation unit 224 as it is.

The packet generation unit 224 generates a packet by adding the header generated by the header generation unit 232 to the payload data supplied from the payload ECC insertion unit 223. In a case where a footer is generated by the footer generation unit 234, the packet generation unit 224 also adds the footer to the payload data.

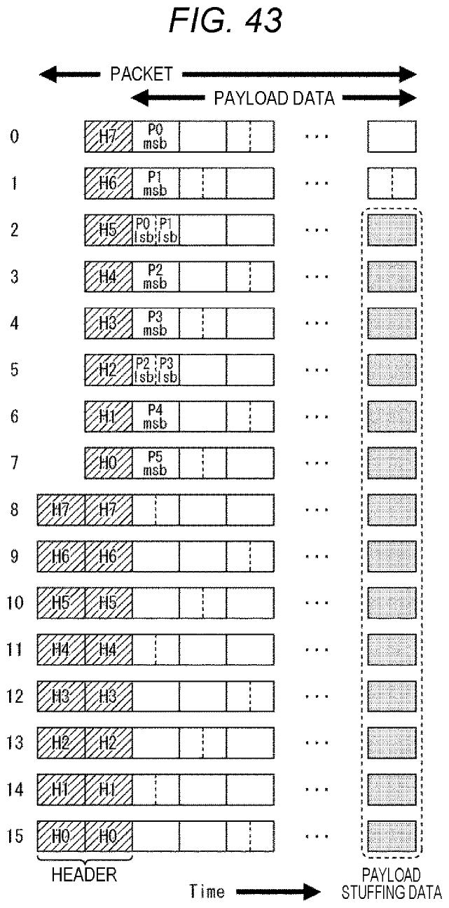

FIG. 43 is a diagram illustrating a state where a header is added to the payload data.

Twenty-four blocks indicated by characters H7 to H0 represent the header information or the header data in byte units, which is the CRC code of the header information. As described with reference to FIG. 3, the header of one packet includes three sets of header information and CRC code.

For example, header data H7 to H2 are header information (six bytes), and header data H1 and H0 are CRC codes (two bytes).

In the example of FIG. 43, one piece of header data H7 is added to the payload data of group 0, and one piece of header data H6 is added to the payload data of group 1. One piece of header data H5 is added to the payload data of group 2, and one piece of header data H4 is added to the payload data of group 3. One piece of header data H3 is added to the payload data of group 4, and one piece of header data H2 is added to the payload data of group 5. One piece of header data H1 is added to the payload data of group 6, and one piece of header data H0 is added to the payload data of group 7.

Furthermore, in the example of FIG. 43, two pieces of header data H7 are added to the payload data of group 8, and two pieces of header data H6 are added to the payload data of group 9. Two pieces of header data H5 are added to the payload data of group 10, and two pieces of header data H4 are added to the payload data of group 11. Two pieces of header data H3 are added to the payload data of group 12, and two pieces of header data H2 are added to the payload data of group 13. Two pieces of header data H1 are added to the payload data of group 14, and two pieces of header data H0 are added to the payload data of group 15.

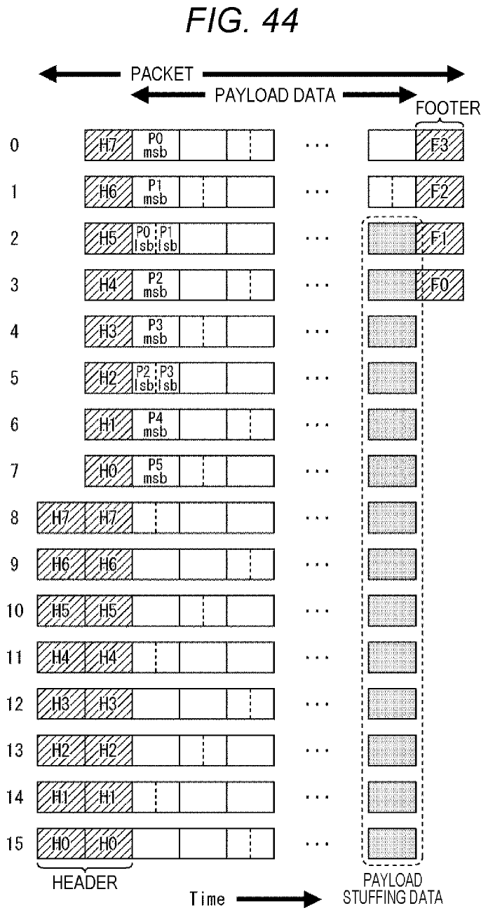

FIG. 44 is a diagram illustrating a state where the header and a footer are added to the payload data.

Four blocks indicated by letters F3 to F0 represent footer data, which is a four-byte CRC code generated as a footer. In the example of FIG. 44, pieces of footer data F3 to F0 are added to the respective payload data of the groups 0 to 3.

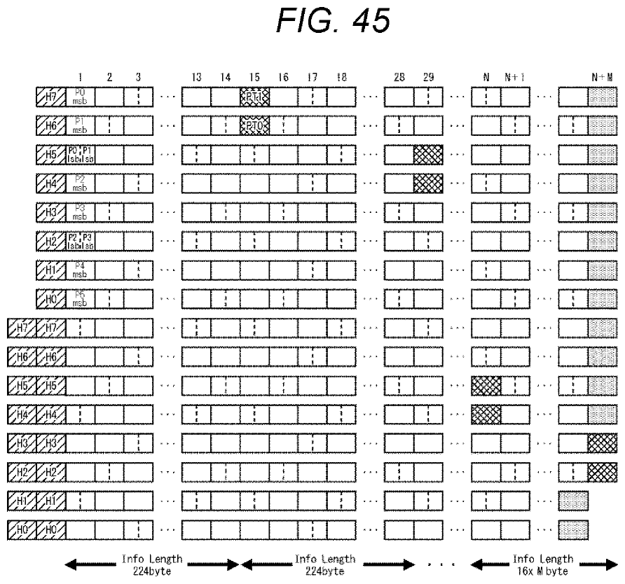

FIG. 45 is a diagram illustrating a state in which the header is added to the payload data in which the parity is inserted.

In the example of FIG. 45, pieces of header data H7 to H0 are added to the payload data of FIG. 42 in which a parity is inserted, as in the cases of FIGS. 43 and 44.

The packet generation unit 224 outputs packet data, which is data constituting one packet generated in this manner, to the lane distribution unit 225. The lane distribution unit 225 is supplied with packet data including header data and payload data, packet data including the header data, the payload data, and footer data, or packet data including the header data and the payload data in which a parity is inserted. The packet structure of FIG. 3 is a logical one, and in the link layer and the physical layer, data of a packet having the structure of FIG. 3 is processed in byte units.

The lane distribution unit 225 assigns the packet data supplied from the packet generation unit 224 to each lane used for data transmission in Lanes 0 to 7 in order from the first data.

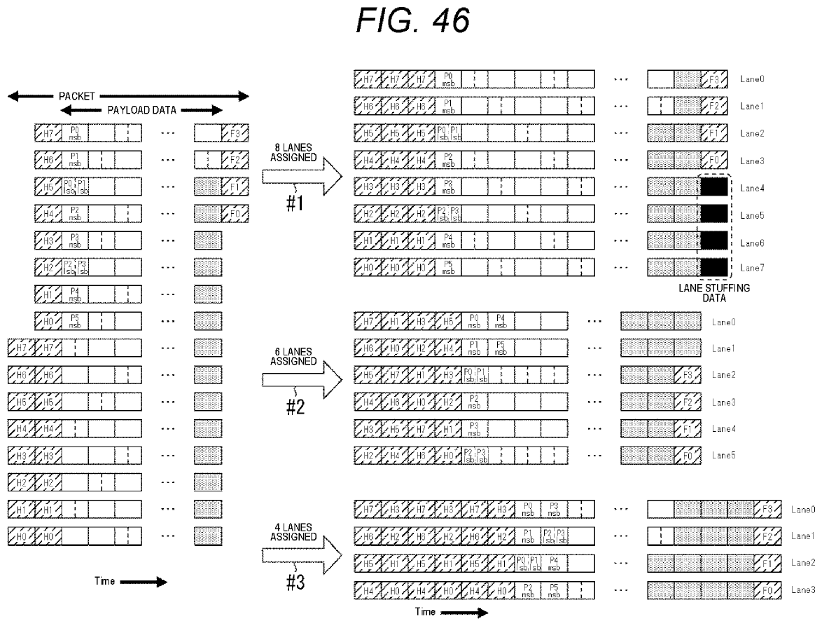

FIG. 46 is a diagram illustrating an example of assignment of the packet data.

Here, an assignment of packet data (FIG. 44) including header data, payload data, and footer data will be described. An example of assignment of packet data in a case where data transmission is performed using eight lanes of Lanes 0 to 7 is illustrated ahead of white arrow #1.

In this case, each piece of header data constituting the header data H7 to H0 repeated three times is assigned to the Lanes 0 to 7 in order from the first header data. When a certain piece of header data is assigned to the Lane 7, header data thereafter is assigned to respective lanes of the Lane 0 and thereafter in order. Three identical pieces of header data will be assigned to each lane of the Lanes 0 to 7.

Furthermore, the payload data is assigned to the Lanes 0 to 7 in order from the first payload data. When a certain piece of payload data is assigned to the Lane 7, payload data thereafter is assigned to respective lanes of the Lane 0 and thereafter in order.

Pieces of footer data F3 to F0 are assigned to each lane in order from the first footer data. In the example of FIG. 46, the last payload stuffing data constituting the payload data is assigned to the Lane 7, and pieces of footer data F3 to F0 are assigned to the Lanes 0 to 3 one by one.

Blocks illustrated in black represent lane stuffing data generated by the data insertion unit 233. The lane stuffing data is assigned to the lane with a small number of pieces of data so that packet data for one packet is assigned to each lane and then a data length assigned to each lane is the same. The lane stuffing data is data of one byte. In the example of FIG. 46, the lane stuffing data is assigned one by one to the Lanes 4 to 7, which are lanes with a small number of data assignments.

The number of pieces of lane stuffing data in a case where the packet data includes header data, payload data, and footer data is represented by following Equation (5).

[Equation 5]

LaneStuffing=LaneNum−((PayloadLength+FooterLength)%LaneNum) (5)

LaneNum in Equation (5) represents the number of lanes, and PayloadLength represents a payload data length (bytes). Furthermore, FooterLength represents a footer length (bytes).

Furthermore, the number of pieces of lane stuffing data in a case where the packet data includes header data and payload data with a parity inserted is represented by following Equation (6). ParityLength in Equation (6) represents the total number of bytes of the parity included in the payload.

[Equation 6]

LaneStuffing=LaneNum−((PayloadLength+ParityLength)%LaneNum) (6)

An example of assignment of packet data in a case where data transmission is performed using the six lanes of the Lanes 0 to 5 is illustrated ahead of white arrow #2.

In this case, each piece of header data constituting the header data H7 to H0 repeated three times is assigned to the Lanes 0 to 5 in order from the first header data. When a certain piece of header data is assigned to the Lane 5, header data thereafter is assigned to respective lanes of the Lane 0 and thereafter in order. Four pieces of header data will be assigned to each lane of the Lanes 0 to 5.

Furthermore, the payload data is assigned to the Lanes 0 to 5 in order from the first payload data. When a certain piece of payload data is assigned to the Lane 5, payload data thereafter is assigned to respective lanes of the Lane 0 and thereafter in order.

Pieces of footer data F3 to F0 are assigned to each lane in order from the first footer data. In the example of FIG. 46, the last payload stuffing data constituting the payload data is assigned to the Lane 1, and pieces of footer data F3 to F0 are assigned to the Lanes 2 to 5 one by one. Since the number of pieces of packet data of the Lanes 0 to 5 is the same, the lane stuffing data is not used in this case.

An example of packet data assignment in a case where data transmission is performed using four lanes of the Lanes 0 to 3 is illustrated ahead of white arrow #3.

In this case, each piece of header data constituting the header data H7 to H0 repeated three times is assigned to the Lanes 0 to 3 in order from the first header data. When a certain piece of header data is assigned to the Lane 3, header data thereafter is assigned to respective lanes of the Lane 0 and thereafter in order. Six pieces of header data will be assigned to each lane of the Lanes 0 to 3.

Furthermore, the payload data is assigned to the Lanes 0 to 3 in order from the first payload data. When a certain piece of payload data is assigned to the Lane 3, payload data thereafter is assigned to respective lanes of the Lane 0 and thereafter in order.

Pieces of footer data F3 to F0 are assigned to each lane in order from the first footer data. In the example of FIG. 46, the last payload stuffing data constituting the payload data is assigned to the Lane 3, and pieces of footer data F3 to F0 are assigned to the Lanes 0 to 3 one by one. Since the number of pieces of packet data of the Lanes 0 to 3 is the same, the lane stuffing data is not used in this case.

The lane distribution unit 225 outputs the packet data assigned to each lane in this manner to the physical layer. Hereinafter, a case where data is transmitted using eight lanes of the Lanes 0 to 7 will be mainly described, but similar processing is performed even in a case where the number of lanes used for data transmission is another number.

Configuration of Physical Layer of Transmission Unit 22

Next, the configuration of the physical layer of the transmission unit 22 will be described.

A physical layer processing unit 22B of the transmission unit 22 is provided with a PHY-TX state control unit 241, a clock generation unit 242, and signal processing units 243-0 to 243-N as the configuration of the physical layer. The signal processing unit 243-0 includes a control code insertion unit 251, an 8B10B symbol encoder 252, a synchronization unit 253, and a transmission unit 254.

For example, the 8B10B symbol encoder 252 corresponds to the 8B10B symbol encoder 54 of FIG. 21. The synchronization unit 253 corresponds to the synchronization unit 81 in FIG. 21. The transmission unit 254 corresponds to the transmission unit 82 in FIG. 21.

Packet data assigned to the Lane 0 output from the lane distribution unit 225 is input to the signal processing unit 243-0, and packet data assigned to the Lane 1 is input to the signal processing unit 243-1. Furthermore, the packet data assigned to the Lane N is input to the signal processing unit 243-N.

In this manner, the physical layer of the transmission unit 22 is provided with the same number of signal processing units 243-0 to 243-N as the number of lanes, and processes of packet data transmitted using respective lanes are performed in parallel in the signal processing units 243-0 to 243-N, respectively. A configuration of the signal processing unit 243-0 will be described, but the signal processing units 243-1 to 243-N also have similar configurations.

The PHY-TX state control unit 241 controls respective units of the signal processing units 243-0 to 243-N. For example, timing of each processing performed by the signal processing units 243-0 to 243-N is controlled by the PHY-TX state control unit 241.

The clock generation unit 242 generates a clock signal and outputs the clock signal to each synchronization unit 253 of the signal processing units 243-0 to 243-N.

The control code insertion unit 251 of the signal processing unit 243-0 adds a control code to packet data supplied from the lane distribution unit 225. The control code is a code represented by one symbol selected from a plurality of types of symbols prepared in advance or by a combination of the plurality of types of symbols. Each symbol inserted by the control code insertion unit 251 is eight-bit data. By performing 8B10B conversion in the circuit in the subsequent stage, one symbol inserted by the control code insertion unit 251 becomes 10-bit data. On the other hand, in the reception unit 31, 10B8B conversion is performed on the received data as described later, but each symbol before the 10B8B conversion included in the received data is 10-bit data, and each symbol after the 10B8B conversion becomes eight-bit data.

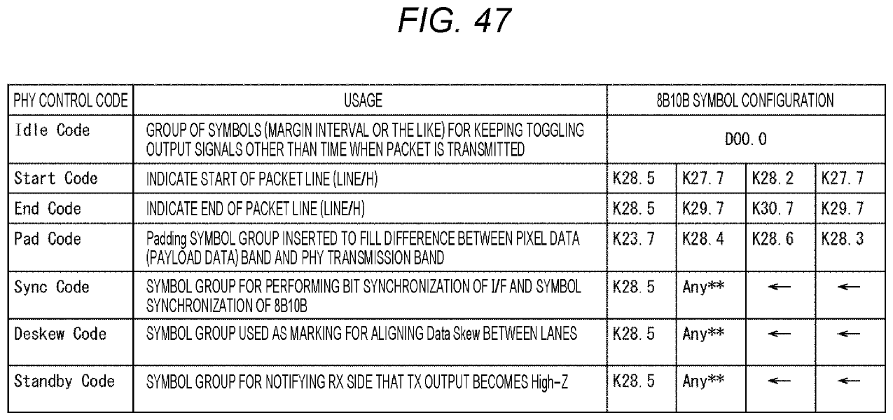

FIG. 47 is a diagram illustrating an example of control codes added by the control code insertion unit 251.

The control codes include Idle Code, Start Code, End Code, Pad Code, Sync Code, Deskew Code, and Standby Code.

The Idle Code is a group of symbols that are repeatedly transmitted during a period other than the time when packet data is transmitted. The Idle Code is represented by D00.0 (00000000) of D Character that is an 8B10B Code.

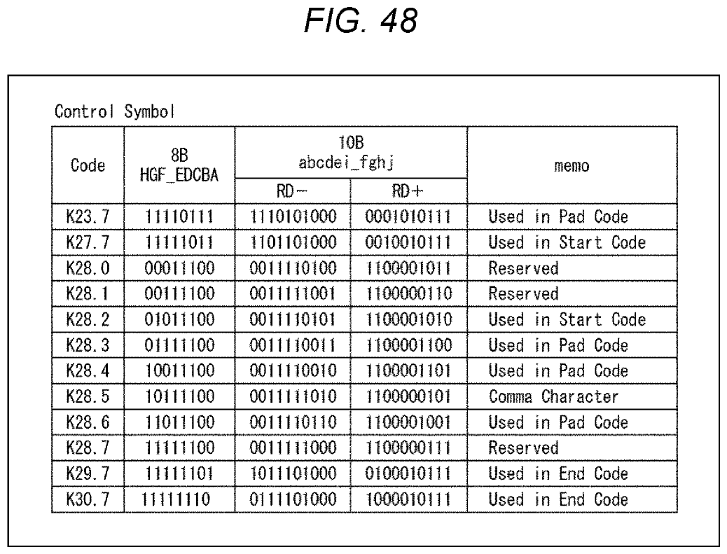

The Start Code is a group of symbols indicating the start of a packet. As described above, the Start Code is added before the packet. The Start Code is represented by four symbols, K28.5, K27.7, K28.2, and K27.7, which are a combination of three types of K Characters. The value of each of K Characters is illustrated in FIG. 48.

The End Code is a group of symbols indicating the end of a packet. As mentioned above, the End Code is added after the packet. The End Code is represented by four symbols, K28.5, K29.7, K30.7, and K29.7, which are a combination of three types of K Characters.

The Pad Code is a group of symbols inserted in payload data to fill the difference between a pixel data band and a PHY transmission band. The pixel data band is a transmission rate of pixel data output from the information processing unit 21 and input to the transmission unit 22, and the PHY transmission band is a transmission rate of pixel data transmitted from the transmission unit 22 and input to the reception unit 31. The Pad Code is represented by four symbols, K23.7, K28.4, K28.6, and K28.3, which are a combination of four types of K Characters.

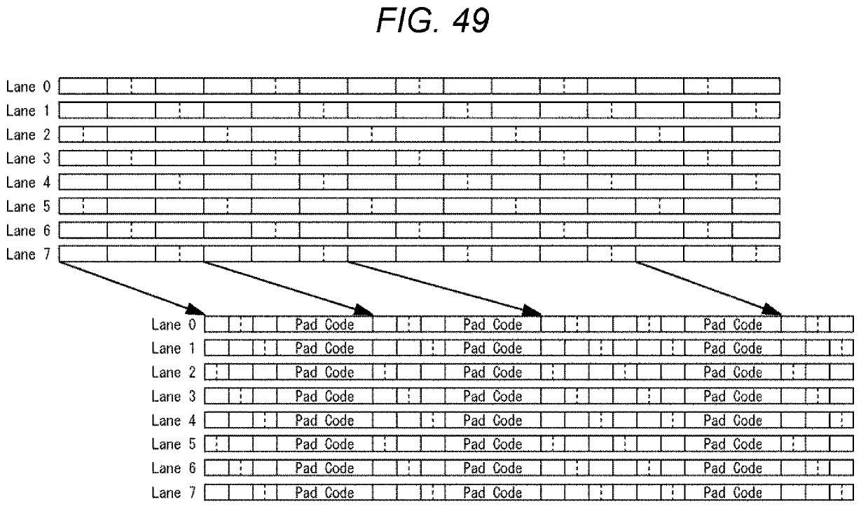

FIG. 49 is a diagram illustrating an example of insertion of the Pad Code.

The upper part of FIG. 49 illustrates payload data assigned to each lane before insertion of the Pad Code, and the lower part illustrates the payload data after insertion of the Pad Code. In the example of FIG. 49, the Pad Code is inserted between the third pixel data and the fourth pixel data from the beginning, between the sixth pixel data and the seventh pixel data, and between the twelfth pixel data and the thirteenth pixel data. In this manner, the Pad Code is inserted at the same position in the payload data of each lane of the Lanes 0 to 7.

The Pad Code is inserted into the payload data assigned to the Lane 0 by the control code insertion unit 251 of the signal processing unit 243-0. Similarly, the Pad Code is inserted in the payload data assigned to the other lanes in the signal processing units 243-1 to 243-N at the same timing. The number of Pad Codes is determined on the basis of the difference between the pixel data band and the PHY transmission band, the frequency of the clock signal generated by the clock generation unit 242, and the like.

In this manner, the Pad Code is inserted to adjust the difference between the two bands in a case where the pixel data band is narrow and the PHY transmission band is wide. For example, by inserting the Pad Code, the difference between the pixel data band and the PHY transmission band is adjusted so as to be within a certain range.

Returning to the description of FIG. 47, the Sync Code is a group of symbols used to secure bit synchronization and symbol synchronization between the transmission unit 22 and the reception unit 31. The Sync Code is represented by two symbols, K28.5 and Any **. Any ** represents that any kind of symbol may be used. The Sync Code is repeatedly transmitted, for example, in the training mode before transmission of packet data is started between the transmission unit 22 and the reception unit 31.

The Deskew Code is a Data Skew between lanes, that is, a group of symbols used for correcting a deviation in reception timing of data received in each lane of the reception unit 31. The Deskew Code is represented by two symbols, K28.5 and Any **. The correction of the Data Skew between lanes using the Deskew Code will be described later.

The Standby Code is a group of symbols used to notify the reception unit 31 that output of the transmission unit 22 is in a state of High-Z (high impedance) or the like and data transmission is no longer performed. That is, the Standby Code is transmitted to the reception unit 31 when transmission of packet data is finished and the Standby state is reached. The Standby Code is represented by two symbols, K28.5 and Any **.

The control code insertion unit 251 outputs packet data to which such a control code is added to the 8B10B symbol encoder 252.

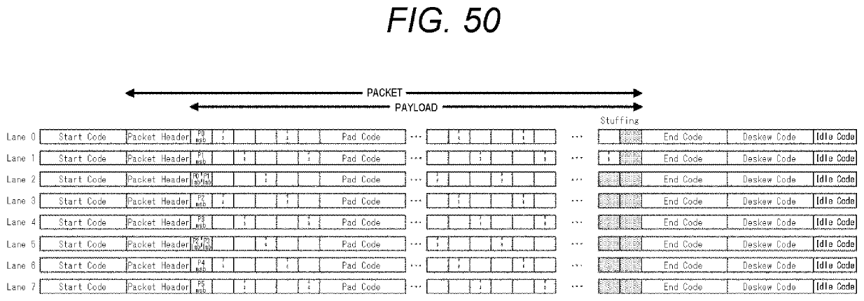

FIG. 50 is a diagram illustrating an example of packet data after insertion of the control code.

As illustrated in FIG. 50, in each of the signal processing units 243-0 to 243-N, the Start Code is added before packet data, and the Pad Code is inserted in the payload data. The End Code is added after the packet data, and the Deskew Code is added after the End Code. In the example of FIG. 50, the Idle Code is added after the Deskew Code.

The 8B10B symbol encoder 252 performs 8B10B conversion on the packet data (packet data to which a control code is added) supplied from the control code insertion unit 251, and outputs the packet data converted into data in 10-bit units to the synchronization unit 253.

The synchronization unit 253 outputs each bit of the packet data supplied from the 8B10B symbol encoder 252 to the transmission unit 254 according to the clock signal generated by the clock generation unit 242. Note that the transmission unit 22 may not be provided with the synchronization unit 253. In this case, the packet data output from the 8B10B symbol encoder 252 is supplied to the transmission unit 254 as it is.

The transmission unit 254 transmits the packet data supplied from the synchronization unit 253 to the reception unit 31 via the transmission line constituting the Lane 0. In a case where data transmission is performed using eight lanes, the packet data is transmitted to the reception unit 31 also using the transmission lines constituting the Lanes 1 to 7.

Configuration of Physical Layer of Reception Unit 31

Next, the configuration of the physical layer of the reception unit 31 will be described.

A physical layer processing unit 31A of the reception unit 31 is provided with a PHY-RX state control unit 301 and signal processing units 302-0 to 302-N as the configuration of the physical layer. The signal processing unit 302-0 includes a reception unit 311, a clock generation unit 312, a synchronization unit 313, a symbol synchronization unit 314, a 10B8B symbol decoder 315, a skew correction unit 316, and a control code removal unit 317.

For example, the reception unit 311 corresponds to the reception unit 111 in FIG. 27. The synchronization unit 313 corresponds to the synchronization unit 112 in FIG. 27. The 10B8B symbol decoder 315 corresponds to the 10B8B symbol decoder 102 in FIG. 27. That is, the configuration illustrated in FIG. 27 is a configuration in which the configuration of the reception unit 31 is simplified.

The packet data transmitted via the transmission line constituting the Lane 0 is input to the signal processing unit 302-0, and the packet data transmitted via the transmission line constituting the Lane 1 is input to the signal processing unit 302-1. Furthermore, the packet data transmitted via the transmission line constituting the Lane N is input to the signal processing unit 302-N.

In this manner, the physical layer of the reception unit 31 is provided with the same number of signal processing units 302-0 to 302-N as the number of lanes, and processes of packet data transmitted using respective lanes are performed in parallel in the signal processing units 302-0 to 302-N, respectively. A configuration of the signal processing unit 302-0 will be described, but the signal processing units 302-1 to 302-N also have similar configurations.

The reception unit 311 receives a signal representing the packet data transmitted from the transmission unit 22 via the transmission line constituting the Lane 0, and outputs the signal to the clock generation unit 312.

The clock generation unit 312 performs bit synchronization by detecting an edge of the signal supplied from the reception unit 311, and generates a clock signal on the basis of detection periods of edges. The clock generation unit 312 outputs the signal supplied from the reception unit 311 to the synchronization unit 313 together with the clock signal.

The synchronization unit 313 samples signals received by the reception unit 311 according to the clock signal generated by the clock generation unit 312, and outputs packet data obtained by the sampling to the symbol synchronization unit 314. The function of the clock data recovery (CDR) is achieved by the clock generation unit 312 and the synchronization unit 313.

The symbol synchronization unit 314 performs symbol synchronization by detecting a control code included in the packet data or by detecting a part of symbols included in the control code. For example, the symbol synchronization unit 314 detects the K28.5 symbols included in the Start Code, the End Code, and the Deskew Code, and performs symbol synchronization. The symbol synchronization unit 314 outputs packet data in 10-bit units representing each symbol to the 10B8B symbol decoder 315.

Furthermore, the symbol synchronization unit 314 performs symbol synchronization by detecting a boundary of symbols included in the Sync Code repeatedly transmitted from the transmission unit 22 in the training mode before transmission of the packet data is started.

The 10B8B symbol decoder 315 performs the 10B8B conversion on the packet data in 10-bit units supplied from the symbol synchronization unit 314, and outputs the packet data converted into data in eight-bit units to the skew correction unit 316.

The skew correction unit 316 detects the Deskew Code from the packet data supplied from the 10B8B symbol decoder 315. Information of detection timing of the Deskew Code by the skew correction unit 316 is supplied to the PHY-RX state control unit 301.

Furthermore, the skew correction unit 316 corrects the Data Skew between lanes by matching the timing of the Deskew Code with a timing represented by information supplied from the PHY-RX state control unit 301. Information representing the latest timing among the Deskew Code timings detected in each of the signal processing units 302-0 to 302-N is supplied from the PHY-RX state control unit 301.

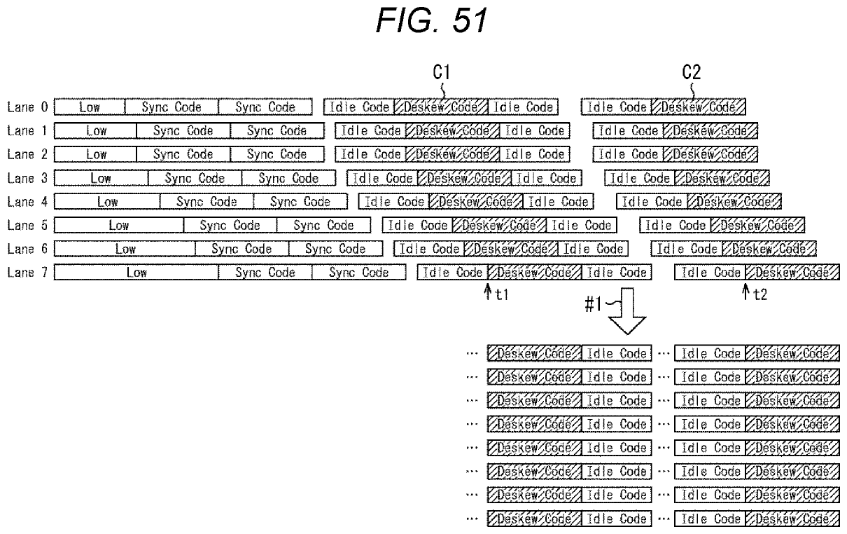

FIG. 51 is a diagram illustrating an example of correction of the Data Skew between lanes using the Deskew Code.

In the example of FIG. 51, Sync Code, Sync Code, . . . , Idle Code, Deskew Code, Idle Code, . . . , Idle Code, Deskew Code are transmitted in respective lanes of the Lanes 0 to 7, and respective control codes are received by the reception unit 31. It is a state where reception timing of the same control code is different for every lane, and the Data Skew between lanes is generated.

In this case, the skew correction unit 316 detects the first Deskew Code, Deskew Code C1, and corrects the first timing of the Deskew Code C1 to match time t1 represented by the information supplied from the PHY-RX state control unit 301. The PHY-RX state control unit 301 supplies information of the time t1 when the Deskew Code C1 is detected in the Lane 7, which is the latest timing among the timings when the Deskew Code C1 is detected in each lane of the Lanes 0 to 7.

Furthermore, the skew correction unit 316 detects the second Deskew Code, Deskew Code C2, and corrects the first timing of Deskew Code C2 to match time t2 represented by the information supplied from the PHY-RX state control unit 301. The PHY-RX state control unit 301 supplies information of the time t2 when the Deskew Code C2 is detected in the Lane 7, which is the latest timing among the timings when the Deskew Code C2 is detected in each lane of the Lanes 0 to 7.

By performing similar processing in each of the signal processing units 302-1 to 302-N, the Data Skew between lanes is corrected as indicated ahead of arrow #1 in FIG. 51.

The skew correction unit 316 outputs packet data corrected by the Data Skew to the control code removal unit 317.

The control code removal unit 317 removes the control code added to the packet data, and outputs data between the Start Code and the End Code to the link layer as packet data.

The PHY-RX state control unit 301 controls each unit of the signal processing units 302-0 to 302-N to perform correction of the Data Skew between lanes, or the like. Furthermore, in a case where the control code is lost due to a transmission error in a predetermined lane, the PHY-RX state control unit 301 adds a control code transmitted in another lane in place of the lost control code, thereby performing error correction for the control code.

Configuration of Link Layer of Reception Unit 31

Next, the configuration of the link layer of the reception unit 31 will be described.

A link layer processing unit 31B of the reception unit 31 is provided with a LINK-RX protocol management unit 321, a lane integration unit 322, a packet separation unit 323, a payload error correction unit 324, and a Byte to Pixel conversion unit 325 as the configuration of the link layer. The LINK-RX protocol management unit 321 includes a state control unit 331, a header error correction unit 332, a data removal unit 333, and a footer error detection unit 334.

For example, the lane integration unit 322 corresponds to the Lane integration unit 103 in FIG. 27. The packet separation unit 323 corresponds to the packet analysis unit 131 and the separation unit 132 in FIG. 27. The Byte to Pixel conversion unit 325 corresponds to the pixel data conversion unit 142 in FIG. 27.

The lane integration unit 322 integrates packet data supplied from the signal processing units 302-0 to 302-N of the physical layer by rearranging the packet data in a reverse order of the distribution order to each lane by the lane distribution unit 225 of the transmission unit 22.

For example, in a case where the packet data is distributed by the lane distribution unit 225 as indicated ahead of arrow #1 in FIG. 46, the packet data in each lane is integrated to acquire the packet data on the left side in FIG. 46. When the packet data of each lane is integrated, the lane stuffing data is removed by the lane integration unit 322 according to control of the data removal unit 333. The lane integration unit 322 outputs the integrated packet data to the packet separation unit 323.

The packet separation unit 323 separates the packet data for one packet integrated by the lane integration unit 322 into packet data constituting header data and packet data constituting payload data. The packet separation unit 323 outputs the header data to the header error correction unit 332 and outputs the payload data to the payload error correction unit 324.

Furthermore, in a case where the packet includes a footer, the packet separation unit 323 separates the data for one packet into packet data constituting header data, packet data constituting payload data, and packet data constituting footer data. The packet separation unit 323 outputs the header data to the header error correction unit 332 and outputs the payload data to the payload error correction unit 324. Furthermore, the packet separation unit 323 outputs the footer data to the footer error detection unit 334.

In a case where a parity is inserted in the payload data supplied from the packet separation unit 323, the payload error correction unit 324 detects an error in the payload data by performing an error correction operation on the basis of the parity, and corrects the detected error. For example, in a case where the parity is inserted as illustrated in FIG. 42, the payload error correction unit 324 uses the two parities inserted at the end of the first Basic Block and performs error correction for 224 pieces of pixel data located before the parity.

The payload error correction unit 324 outputs the pixel data after error correction obtained by performing error correction for each Basic Block and Extra Block to the Byte to Pixel conversion unit 325. In a case where the parity is not inserted in the payload data supplied from the packet separation unit 323, the payload data supplied from the packet separation unit 323 is output to the Byte to Pixel conversion unit 325 as it is.

The Byte to Pixel conversion unit 325 removes payload stuffing data included in the payload data supplied from the payload error correction unit 324 according to control of the data removal unit 333.

Furthermore, the Byte to Pixel conversion unit 325 performs the Byte to Pixel conversion that converts the data of each pixel in byte units obtained by removing the payload stuffing data into pixel data in eight-bit, 10-bit, 12-bit, 14-bit, or 16-bit units. In the Byte to Pixel conversion unit 325, conversion opposite to the Pixel to Byte conversion by the Pixel to Byte conversion unit 222 of the transmission unit 22 described with reference to FIGS. 35 to 39 is performed.

The Byte to Pixel conversion unit 325 outputs pixel data in eight-bit, 10-bit, 12-bit, 14-bit, or 16-bit units obtained by the Byte to Pixel conversion to the frame data output unit 341. In the frame data output unit 341, for example, each line of effective pixels specified by the Line Valid of the header information is generated on the basis of the pixel data obtained by the Byte to Pixel conversion unit 325, and each line is arranged according to the Line Number of the header information, thereby generating an image of one frame.

The state control unit 331 of the LINK-RX protocol management unit 321 manages the state of the link layer of the reception unit 31.

The header error correction unit 332 acquires three sets of header information and CRC code on the basis of the header data supplied from the packet separation unit 323. The header error correction unit 332 performs, for each set of the header information and the CRC code, an error detection operation that is an operation for detecting an error in the header information by using the CRC code of the same set as the header information.

Furthermore, the header error correction unit 332 estimates correct header information on the basis of at least one of an error detection result of the header information of each set or a comparison result of data obtained by the error detection operation, and outputs header information estimated to be correct and a decoding result. The data obtained by the error detection operation is a value obtained by applying a CRC generation polynomial to the header information. Furthermore, the decoding result is information representing success or failure of decoding.

The three sets of header information and CRC code are set as a set 1, a set 2, and a set 3, respectively. In this case, the header error correction unit 332 acquires whether or not there is an error in the header information of the set 1 (error detection result) by the error detection operation for the set 1, and data 1 obtained by the error detection operation. Furthermore, the header error correction unit 332 acquires whether or not there is an error in the header information of the set 2 by the error detection operation for the set 2, and data 2 obtained by the error detection operation. The header error correction unit 332 acquires whether or not there is an error in the header information of the set 3 by the error detection operation for the set 3, and data 3 obtained by the error detection operation.

Furthermore, the header error correction unit 332 determines whether or not the data 1 and the data 2 match, whether or not the data 2 and the data 3 match, and whether or not the data 3 and the data 1 match.

For example, in a case where no errors are detected by all error detection operations for set 1, set 2, and set 3 and all comparison results of data obtained by the error detection operation match, the header error correction unit 332 selects information representing successful decoding as a decoding result. Furthermore, the header error correction unit 332 estimates that all the header information is correct, and selects one of the header information of the set 1, the header information of the set 2, and the header information of the set 3 as output information.

On the other hand, in a case where no errors are detected only by the error detection operation for the set 1, the header error correction unit 332 selects information representing success of decoding as a decoding result and estimates that the header information of the set 1 is correct, and selects the header information of the set 1 as output information.

Furthermore, in a case where no errors are detected only by the error detection operation for the set 2, the header error correction unit 332 selects information representing success of decoding as a decoding result and estimates that the header information of the set 2 is correct, and selects the header information of the set 2 as output information.

In a case where no errors are detected only by the error detection operation for the set 3, the header error correction unit 332 selects information representing success of decoding as a decoding result and estimates that the header information of the set 3 is correct, and selects the header information of the set 3 as output information.

The header error correction unit 332 outputs the decoding result and the output information selected as described above to the register 342 to have them stored. In this manner, the error correction of the header information by the header error correction unit 332 is performed by detecting the header information without an error from a plurality of pieces of header information by using the CRC code and outputting the detected header information.

The data removal unit 333 controls the lane integration unit 322 to remove the lane stuffing data, and controls the Byte to Pixel conversion unit 325 to remove the payload stuffing data.

The footer error detection unit 334 acquires a CRC code stored in the footer on the basis of the footer data supplied from the packet separation unit 323. The footer error detection unit 334 performs an error detection operation using the acquired CRC code and detects an error in the payload data. The footer error detection unit 334 outputs an error detection result to have it stored in the register 342.

### Modification Example

Although the case of employing the multi-gradation transmission method in the data transmission of the SLVS-EC standard has been described, the multi-gradation transmission method can also be applied to data transmission of another standard in which a frame having a predetermined format is defined and data in line units is transmitted using one packet.

Examples of such a standard include the MIPI standard.

By employing the multi-gradation transmission method in data transmission of the MIPI standard, efficient data transmission can be performed as described above.
Configuration example of computer The series of processes described above can be executed by hardware or can be executed by software. In a case where the series of processes is executed by software, a program constituting the software is installed on a computer built into dedicated hardware or a general-purpose personal computer from a program recording medium, or the like.

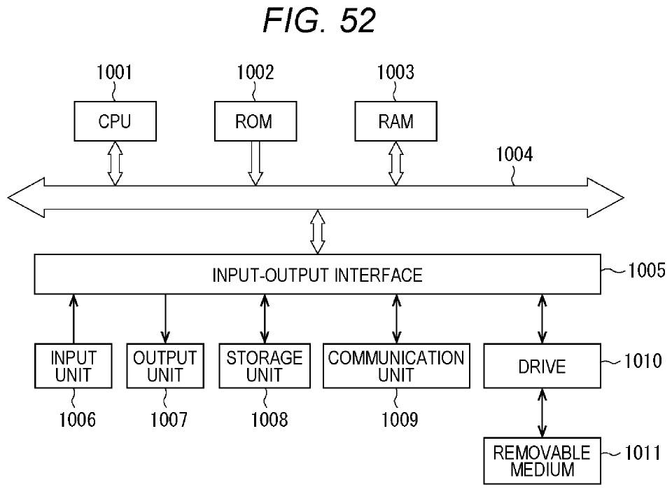

FIG. 52 is a block diagram illustrating a configuration example of hardware of a computer that executes the above-described series of processes by a program.

A central processing unit (CPU) 1001, a read only memory (ROM) 1002, and a random access memory (RAM) 1003 are interconnected via a bus 1004.

An input-output interface 1005 is further connected to the bus 1004. An input unit 1006 including a keyboard, a mouse, and the like, and an output unit 1007 including a display, a speaker, and the like are connected to the input-output interface 1005. Furthermore, the input-output interface 1005 is connected to a storage unit 1008 including a hard disk and a non-volatile memory and the like, a communication unit 1009 including a network interface and the like, and a drive 1010 that drives a removable medium 1011.

In the computer configured as described above, for example, the CPU 1001 loads a program stored in the storage unit 1008 into the RAM 1003 via the input-output interface 1005 and the bus 1004 and executes the program, to thereby perform the above-described series of processes.

For example, the program to be executed by the CPU 1001 is recorded on the removable medium 1011 or provided via a wired or wireless transmission medium such as a local area network, the Internet, or a digital broadcast, and installed in the storage unit 1008.

Note that the program executed by the computer may be a program for processing in time series in the order described in the present description, or a program for processing in parallel or at a necessary timing such as when a call is made.

The effects described herein are merely examples and are not limited, and other effects may be provided.

The embodiments of the present technology are not limited to the above-described embodiments, and various modifications are possible without departing from the gist of the present technology.

For example, the present technology can employ a configuration of cloud computing in which one function is shared by a plurality of devices via a network and processed jointly.

Furthermore, each step described in the above-described flowcharts can be executed by one device, or can be executed in a shared manner by a plurality of devices.

Moreover, in a case where a plurality of processes is included in one step, the plurality of processes included in the one step can be executed in a shared manner by a plurality of devices in addition to being executed by one device.

<Example of Combinations of Configurations>

The present technology can also employ the following configurations.

(1)

A transmission device including:

a packet generation unit that generates a packet used for transmission of data of each line constituting a frame in which data to be transmitted is arranged in a predetermined format by adding, to a payload storing a plurality of types of unit data having different bit widths for each data unit, a header including separation information including an identifier representing that the plurality of types of the unit data is stored in the payload; and

a transmission unit that transmits the packet.

(2)

The transmission device according to (1) above, in which the packet generation unit generates the payload in which a bit width of the unit data is periodically switched.

(3)

The transmission device according to (2) above, in which

the packet generation unit generates the payload in which the unit data having a same bit width is continuously stored.

(4)

The transmission device according to (2) or (3) above, in which

the packet generation unit adds the header including, as the separation information, information representing at least one of an arrangement order of the unit data or a switching period of the bit width together with mode information representing that the bit width is periodically switched.

(5)

The transmission device according to any one of (2) to (4) above, in which

the packet generation unit generates the packet including the payload in which pixels constituting respective images obtained by imaging by a plurality of imaging elements are stored as the unit data.

(6)

The transmission device according to (1) above, in which

the packet generation unit generates the payload in which a bit width of the unit data is partially switched.

(7)

The transmission device according to (6) above, in which

the packet generation unit adds the header including, as the separation information, information representing at least one of a number of portions at which the bit width of the unit data is switched, start positions of the portions, or widths of the portions together with mode information representing that the bit width is partially switched.

(8)

The transmission device according to (6) or (7) above, in which

the packet generation unit generates the packet including the payload in which pixels constituting a region of interest and pixels constituting a non-region of interest that are detected by analyzing an image are stored as the unit data having different bit widths.

(9)

The transmission device according to any one of (1) to (8) above, in which

the packet generation unit stores, in a head of the payload, a part of the separation information that is not capable of being stored in the header having a data length defined in the predetermined format.

(10)

The transmission device according to (1) above, in which

the packet generation unit generates the packet including the payload in which information of each item representing a measurement result of a predetermined sensor is stored as the unit data.

(11)

The transmission device according to any one of (1) to (11) above, in which

the transmission unit distributes packet data constituting the packet into a plurality of lanes, performs processing including insertion of control information on the packet data of each of the lanes in parallel, and outputs the packet data obtained by performing the processing on a transmission line between a reception device.

(12)

A transmission method including, by a transmission device:

generating a packet used for transmission of data of each line constituting a frame in which data to be transmitted is arranged in a predetermined format by adding, to a payload storing a plurality of types of unit data having different bit widths for each data unit, a header including separation information including an identifier representing that the plurality of types of the unit data is stored in the payload; and

transmitting the packet.

(13)

A reception device including:

a reception unit that receives a packet that is used for transmission of data of each line constituting a frame in which data to be transmitted is arranged in a predetermined format and is generated by adding, to a payload storing a plurality of types of unit data having different bit widths for each data unit, a header including separation information including an identifier representing that the plurality of types of the unit data is stored in the payload; and

a separation unit that separates respective pieces of the unit data having different bit widths on the basis of the separation information and outputs the unit data.

(14)

The reception device according to (13) above, in which

the separation unit separates the unit data from the payload in which a bit width of the unit data is periodically switched.

(15)

The reception device according to (14) above, in which

the separation unit separates the unit data on the basis of the separation information including information representing at least one of an arrangement order of the unit data or a switching period of the bit width together with mode information representing that the bit width is periodically switched.

(16)

The reception device according to (13) above, in which

the separation unit separates the unit data from the payload in which a bit width of the unit data is partially switched.

(17)

The reception device according to (16) above, in which

the separation unit separates the unit data on the basis of mode information representing that the bit width is partially switched and the separation information including information representing at least one of a number of portions at which the bit width of the unit data is switched, start positions of the portions, or widths of the portions.

(18)

The reception device according to any one of (13) to (17) above, in which

the reception unit receives packet data output on a transmission line in parallel from a transmission device as data of a plurality of lanes, and

the separation unit separates the unit data from the payload of the packet obtained by integrating the packet data of each of the lanes into data of one system.

(19)

A reception method including, by a reception device:

receiving a packet that is used for transmission of data of each line constituting a frame in which data to be transmitted is arranged in a predetermined format and is generated by adding, to a payload storing a plurality of types of unit data having different bit widths for each data unit, a header including separation information including an identifier representing that the plurality of types of the unit data is stored in the payload; and

separating respective pieces of the unit data having different bit widths on the basis of the separation information and outputting the unit data.

(20)

A transmission-reception device including:

a transmission device that includes

a packet generation unit that generates a packet used for transmission of data of each line constituting a frame in which data to be transmitted is arranged in a predetermined format by adding, to a payload storing a plurality of types of unit data having different bit widths for each data unit, a header including separation information including an identifier representing that the plurality of types of the unit data is stored in the payload, and

a transmission unit that transmits the packet; and

a reception device that includes

a reception unit that receives the packet, and

a separation unit that separates respective pieces of the unit data having different bit widths on the basis of the separation information and outputs the unit data.

### REFERENCE SIGNS LIST

1 Transmission system
11 Transmission-side LSI
12 Reception-side LSI
21 Information processing unit
22 Transmission unit
31 Reception unit
32 Information processing unit
51-1 Core
51-2 Core_sub
52 Memory
53 Lane distribution unit
54 8B10B symbol encoder
55 PHY analog processing unit
61 Signal processing unit
62 Control unit
63 State control unit
71 Packing unit
72 Header-footer generation unit
73 Packet generation unit
101 PHY analog processing unit
102 10B8B symbol decoder
103 Lane integration unit
104 Core
121 Signal processing unit
122 Control unit
123 State control unit
131 Packet analysis unit
132 Separation unit
133-1, 133-2 Output unit

1. A transmission device comprising:
a packet generation unit that generates a packet used for transmission of data of each line constituting a frame in which data to be transmitted is arranged in a predetermined format by adding, to a payload storing a plurality of types of unit data having different bit widths for each data unit, a header including separation information including an identifier representing that the plurality of types of the unit data is stored in the payload; and
a transmission unit that transmits the packet.

2. The transmission device according to claim 1, wherein
the packet generation unit generates the payload in which a bit width of the unit data is periodically switched.

3. The transmission device according to claim 2, wherein
the packet generation unit generates the payload in which the unit data having a same bit width is continuously stored.

4. The transmission device according to claim 2, wherein
the packet generation unit adds the header including, as the separation information, information representing at least one of an arrangement order of the unit data or a switching period of the bit width together with mode information representing that the bit width is periodically switched.

5. The transmission device according to claim 2, wherein
the packet generation unit generates the packet including the payload in which pixels constituting respective images obtained by imaging by a plurality of imaging elements are stored as the unit data.

6. The transmission device according to claim 1, wherein
the packet generation unit generates the payload in which a bit width of the unit data is partially switched.

7. The transmission device according to claim 6, wherein
the packet generation unit adds the header including, as the separation information, information representing at least one of a number of portions at which the bit width of the unit data is switched, start positions of the portions, or widths of the portions together with mode information representing that the bit width is partially switched.

8. The transmission device according to claim 6, wherein
the packet generation unit generates the packet including the payload in which pixels constituting a region of interest and pixels constituting a non-region of interest that are detected by analyzing an image are stored as the unit data having different bit widths.

9. The transmission device according to claim 1, wherein
the packet generation unit stores, in a head of the payload, a part of the separation information that is not capable of being stored in the header having a data length defined in the predetermined format.

10. The transmission device according to claim 1, wherein
the packet generation unit generates the packet including the payload in which information of each item representing a measurement result of a predetermined sensor is stored as the unit data.

11. The transmission device according to claim 1, wherein
the transmission unit distributes packet data constituting the packet into a plurality of lanes, performs processing including insertion of control information on the packet data of each of the lanes in parallel, and outputs the packet data obtained by performing the processing on a transmission line between a reception device.

12. A transmission method comprising, by a transmission device:
generating a packet used for transmission of data of each line constituting a frame in which data to be transmitted is arranged in a predetermined format by adding, to a payload storing a plurality of types of unit data having different bit widths for each data unit, a header including separation information including an identifier representing that the plurality of types of the unit data is stored in the payload; and
transmitting the packet.

13. A reception device comprising:
a reception unit that receives a packet that is used for transmission of data of each line constituting a frame in which data to be transmitted is arranged in a predetermined format and is generated by adding, to a payload storing a plurality of types of unit data having different bit widths for each data unit, a header including separation information including an identifier representing that the plurality of types of the unit data is stored in the payload; and
a separation unit that separates respective pieces of the unit data having different bit widths on a basis of the separation information and outputs the unit data.

14. The reception device according to claim 13, wherein
the separation unit separates the unit data from the payload in which a bit width of the unit data is periodically switched.

15. The reception device according to claim 14, wherein
the separation unit separates the unit data on a basis of the separation information including information representing at least one of an arrangement order of the unit data or a switching period of the bit width together with mode information representing that the bit width is periodically switched.

16. The reception device according to claim 13, wherein
the separation unit separates the unit data from the payload in which a bit width of the unit data is partially switched.

17. The reception device according to claim 16, wherein
the separation unit separates the unit data on a basis of mode information representing that the bit width is partially switched and the separation information including information representing at least one of a number of portions at which the bit width of the unit data is switched, start positions of the portions, or widths of the portions.

18. The reception device according to claim 13, wherein
the reception unit receives packet data output on a transmission line in parallel from a transmission device as data of a plurality of lanes, and
the separation unit separates the unit data from the payload of the packet obtained by integrating the packet data of each of the lanes into data of one system.

19. A reception method comprising, by a reception device:
receiving a packet that is used for transmission of data of each line constituting a frame in which data to be transmitted is arranged in a predetermined format and is generated by adding, to a payload storing a plurality of types of unit data having different bit widths for each data unit, a header including separation information including an identifier representing that the plurality of types of the unit data is stored in the payload; and
separating respective pieces of the unit data having different bit widths on a basis of the separation information and outputting the unit data.

20. A transmission-reception device comprising:
a transmission device that includes
a packet generation unit that generates a packet used for transmission of data of each line constituting a frame in which data to be transmitted is arranged in a predetermined format by adding, to a payload storing a plurality of types of unit data having different bit widths for each data unit, a header including separation information including an identifier representing that the plurality of types of the unit data is stored in the payload, and
a transmission unit that transmits the packet; and
a reception device that includes
a reception unit that receives the packet, and
a separation unit that separates respective pieces of the unit data having different bit widths on a basis of the separation information and outputs the unit data.
